(19) United States
(12) Patent Application Publication
(10) Pub. No.: US 2023/0135569 A1
(43) Pub. Date: May 4, 2023

(54) AUTHENTICATION SERVER, AUTHENTICATION SYSTEM, AND AUTHENTICATION SERVER CONTROL METHOD

(71) Applicant: NEC Corporation, Minato-ku, Tokyo (JP)

(72) Inventor: Yoshiaki Okuyama, Tokyo (JP)

(73) Assignee: NEC Corporation, Minato-ku, Tokyo (JP)

(21) Appl. No.: 17/918,159

(22) PCT Filed: Apr. 24, 2020
(86) PCT No.: PCT/JP2020/017660

§ 371 Date: Oct. 11, 2022

(51) Int. Cl. G06F 21/32

(52) U.S. Cl. CPC G06F 21/32

(57) ABSTRACT

Provided is an authentication server that ensures sufficient precision of biometric authentication. The authentication server includes a first database and an authentication unit. The first database stores user authentication information for some users out of a plurality of users. The user authentication information is used to perform authentication by using biometric information. The authentication unit uses the user authentication information stored in the first database to process an authentication request from a terminal.

### TECHNICAL FIELD

The present invention relates to an authentication server, an authentication system, an authentication server control method, and a storage medium.

### BACKGROUND ART

In recent years, various services using biometric information have started to spread. For example, face authentication is used for various procedures performed in an airport (check-in, baggage check-in, etc.), for check-in at a hotel, or the like.

For example, PTL 1 describes that payment is correctly performed even when face authentication processing is not correctly performed.

### CITATION LIST

### Patent Literature

[PTL 1] JP 2020-030669 A

### SUMMARY OF INVENTION

### Technical Problem

As described above, it has been studied to provide various services using biometric authentication. In such a system using biometric authentication, a terminal for face authentication is installed in a hotel or the like, and biometric information is transmitted from the terminal to a server. The server performs collation processing using biometric information registered in the database together with the acquired biometric information to specify a user. Here, when the scale of the face authentication service increases, a large number of pieces of similar biometric information (face images or feature amounts generated from the face images) are registered in the database, resulting in a decrease in precision of authentication.

A main object of the present invention is to provide an authentication server, an authentication system, an authentication server control method, and a storage medium that contribute to ensuring sufficient precision of biometric authentication.

### Solution to Problem

According to a first aspect of the present invention, there is provided an authentication server including: a first database that stores user authentication information for performing authentication using biometric information for some of a plurality of users; and an authentication unit that processes an authentication request from a terminal using the user authentication information stored in the first database.

According to a second aspect of the present invention, there is provided an authentication system including: a plurality of authentication servers, each including a first database that stores user authentication information for performing authentication using biometric information for some of a plurality of users; and an authentication terminal that transmits an authentication request including biometric information for the user to a predetermined authentication server among the plurality of authentication servers, in which the authentication server receiving the authentication request processes the received authentication request using the user authentication information stored in the first database.

According to a third aspect of the present invention, there is provided an authentication server control method performed by an authentication server, the authentication server control method including: storing, in a first database, user authentication information for performing authentication using biometric information for some of a plurality of users; and processing an authentication request from a terminal using the user authentication information stored in the first database.

According to a fourth aspect of the present invention, there is provided a computer-readable storage medium storing a program for causing a computer mounted on an authentication server to execute processing including: storing, in a first database, user authentication information for performing authentication using biometric information for some of a plurality of users; and processing an authentication request from a terminal using the user authentication information stored in the first database.

### Advantageous Effects of Invention

According to each aspect of the present invention, an authentication server, an authentication system, an authentication server control method, and a storage medium that contribute to ensuring sufficient precision of biometric authentication are provided. Note that the effect of the present invention is not limited thereto. The present invention may have other effects instead of or in addition to the above-described effect.

### BRIEF DESCRIPTION OF DRAWINGS

FIG. 1 is a diagram for explaining an outline of an example embodiment.

FIG. 2 is a diagram illustrating an example of a schematic configuration of an authentication system according to a first example embodiment.

FIG. 3 is a diagram for explaining an operation in a user registration phase of the authentication system according to the first example embodiment.

FIG. 4 is a diagram for explaining an operation in a service registration phase of the authentication system according to the first example embodiment.

FIG. 5 is a diagram for explaining an operation in a service provision phase of the authentication system according to the first example embodiment.

FIG. 6 is a diagram for explaining an operation in a service provision phase of the authentication system according to the first example embodiment.

FIG. 7 is a diagram for explaining an operation in a service provision phase of the authentication system according to the first example embodiment.

FIG. 8 is a diagram illustrating an example of a processing configuration of an authentication server according to the first example embodiment.

FIG. 9 is a diagram for explaining an operation of a user registration unit of the authentication server according to the first example embodiment.

FIG. 10 is a diagram for explaining an operation of the user registration unit of the authentication server according to the first example embodiment.

FIG. 11 is a diagram illustrating an example of an authentication information database.

FIG. 12 is a diagram illustrating an example of an authentication information database.

FIG. 13 is a diagram illustrating an example of an authentication information database.

FIG. 14 is a diagram illustrating an example of a temporary authentication information database.

FIG. 15 is a diagram illustrating an example of a processing configuration of a management server according to the first example embodiment.

FIG. 16 is a diagram for explaining an operation of a personal information acquisition unit of the management server according to the first example embodiment.

FIG. 17 is a diagram illustrating an example of a user information database.

FIG. 18 is a diagram illustrating an example of a processing configuration of an authentication terminal according to the first example embodiment.

FIG. 19 is a diagram illustrating an example of a processing configuration of a terminal according to the first example embodiment.

FIG. 20 is a sequence diagram illustrating an example of the operation of the authentication system related to the service registration phase according to the first example embodiment.

FIG. 21 is a sequence diagram illustrating an example of the operation of the authentication system related to the service provision phase according to the first example embodiment.

FIG. 22 is a sequence diagram illustrating an example of the operation of the authentication system related to the service provision phase according to the first example embodiment.

FIG. 23 is a sequence diagram illustrating an example of the operation of the authentication system related to the service provision phase according to the first example embodiment.

FIG. 24 is a diagram illustrating an example of a hardware configuration of the authentication server.

### EXAMPLE EMBODIMENT

First, an outline of an example embodiment will be described. Note that the reference signs added to this outline are attached to the respective elements for convenience as an example for assisting understanding, and the description of this outline does not intend any limitation. In addition, unless particularly explained, a block used in each drawing represents a functional unit rather than a hardware unit. A connection line between blocks in each drawing refers to both a bidirectional line and a unidirectional line. A unidirectional arrow schematically indicates a flow of a main signal (data), and does not exclude bidirectionality. Note that, in the present specification and the drawings, elements that can be similarly described are denoted by the same reference signs, and redundant description can be omitted.

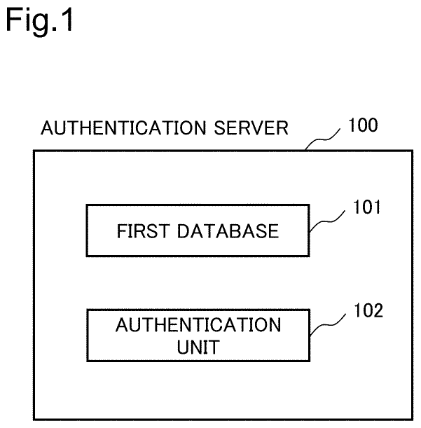

An authentication server 100 according to an example embodiment includes a first database 101 and an authentication unit 102 (see FIG. 1). The first database 101 stores user authentication information for performing authentication using biometric information for some of a plurality of users. The authentication unit 102 processes an authentication request from a terminal using the user authentication information stored in the first database.

An authentication system includes a plurality of authentication servers 100, and each authentication server 100 stores information for some of all system users (user authentication information for biometrically authenticating the users). In addition, each authentication server 100 basically processes an authentication request from a terminal using the user authentication information stored in itself. That is, in an authentication system according to an example embodiment, a plurality of authentication servers 100 that manage user authentication information are provided, and the authentication information is allocated to the authentication servers 100 in a distributed manner. As a result, an amount of data stored (managed) by each authentication server 100 is reduced, thereby preventing a deterioration in precision of authentication. In other words, by allocating the user authentication information in the distributed manner, it is possible to ensure sufficient precision of biometric authentication.

Hereinafter, specific example embodiments will be described in more detail with reference to the drawings.

### First Example Embodiment

A first example embodiment will be described in more detail with reference to the drawings.

### [Configuration of System]

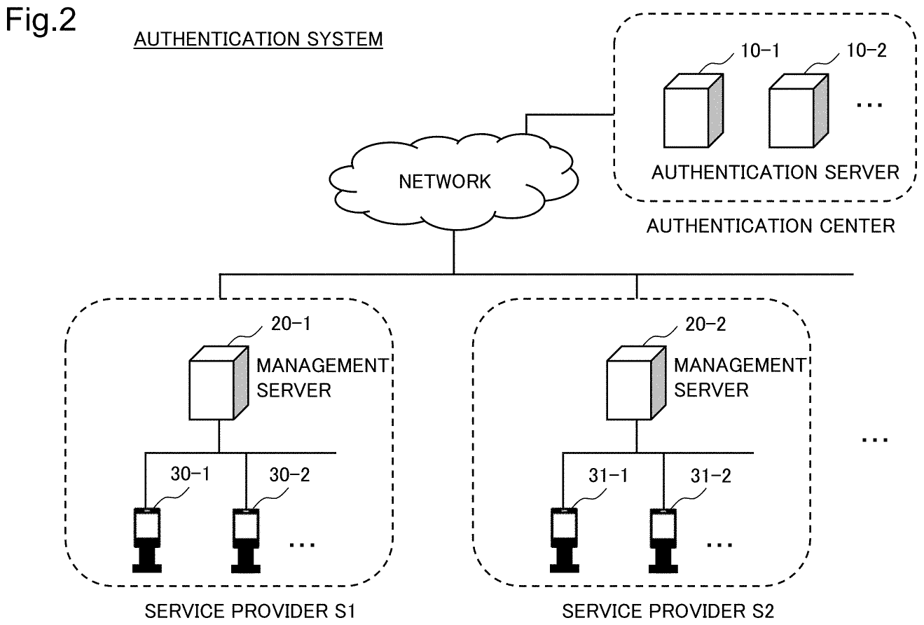

FIG. 2 is a diagram illustrating an example of a schematic configuration of an authentication system according to the first example embodiment. As illustrated in FIG. 2, the authentication system includes an authentication center and a plurality of service providers.

Each of the service providers participating in the authentication system provides a service using biometric authentication. Examples of the service provided by the service provider include a payment service at a retail store or the like and an accommodation service at a hotel or the like. Alternatively, the service provided by the service provider may be an immigration inspection or the like at an airport or a port. The service provider disclosed in the present application provides any service that can be provided using biometric authentication.

In the authentication center, a plurality of authentication servers 10-1 and 10-2 are installed. In the following description, unless required to be distinguished from each other, the authentication servers 10-1 and 10-2 will be simply referred to as “authentication servers 10”. Similarly, for other components, reference numerals on the left sides of hyphens will be used to represent the components.

The authentication server 10 installed in the authentication center operates as an authentication authority for authentication using biometric information. The authentication server 10 may be a server installed at a site of the authentication center or a server installed on a cloud.

Note that the biometric information of the user includes, for example, data (a feature amount) calculated from a physical feature unique to an individual, such as a face, a fingerprint, a voiceprint, a vein, a retina, or a pattern of an iris of a pupil. Alternatively, the biometric information of the user may be image data such as a face image or a fingerprint image. The biometric information of the user only needs to include a physical feature of the user as information.

The authentication server 10 is a server device for enabling a service based on biometric authentication. The authentication server 10 processes an “authentication request” transmitted from each service provider and transmits an authentication processing result to the service provider.

Each service provider has a management server and an authentication terminal.

For example, a management server 20 and a plurality of authentication terminals 30 are installed in the service provider S1. In the service provider S2, a management server 20 and a plurality of authentication terminals 31 are installed. Since the operations and the like of the respective devices included in the service provider S1 and the service provider S2 can be the same, the following description will focus on the service provider S1.

The devices illustrated in FIG. 2 are connected to each other. For example, the authentication server 10 and the management server 20 are connected to each other by a means of wired or wireless communication, and are configured to be able to communicate with each other.

The management server 20 is a server that controls and manages overall operations of the service provider. For example, in a case where the service provider is a retail store, the management server 20 manages product stocks and the like. Alternatively, if the service provider is a hotel business operator, the management server 20 manages information on reservations of guests and the like.

The authentication terminal 30 is a device serving as an interface of a user (visitor) who has visited a service provider. The user is provided with various services via the authentication terminal 30. For example, in a case where the service provider is a retail store, the user makes a payment using the authentication terminal 30. Alternatively, if the service provider is a hotel business operator, the user checks in using the authentication terminal 30.

The configuration illustrated in FIG. 2 is an example, and is not intended to limit the configuration and the like of the authentication system disclosed in the present application. For example, the authentication center may include three or more authentication servers 10. Alternatively, the service provider only needs to include at least one authentication terminal 30. Alternatively, the functions of the management server 20 and the authentication terminal 30 may be integrated, and a service using biometric authentication may be provided by one integrated device. Alternatively, in each service provider, a plurality of authentication terminals 30 may be connected to one management server 20 as illustrated in FIG. 2, or one authentication terminal 30 may be connected to one management server 20.

### [Schematic Operation of System]

Next, a schematic operation of the authentication system according to the first example embodiment will be described.

The operation of the authentication system includes three phases.

The first phase is a phase in which a user is registered in the system (user registration phase).

The second phase is a phase in which a service is registered (service registration phase).

The third phase is a phase in which the service using biometric authentication is provided to the user (service provision phase).

### [User Registration Phase]

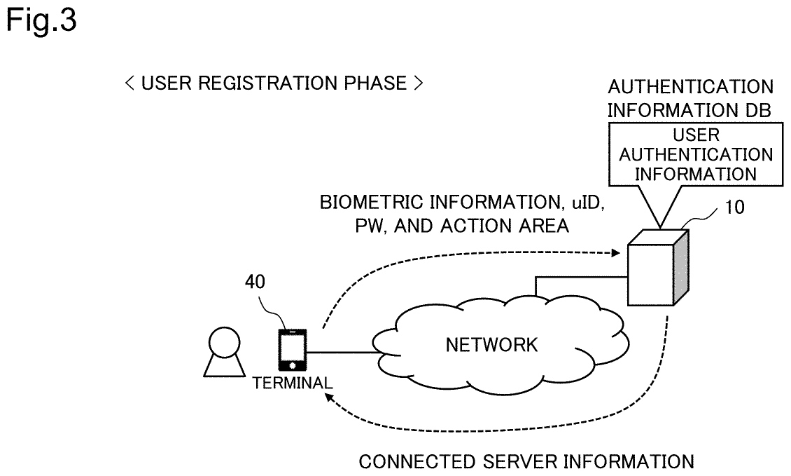

FIG. 3 is a diagram for explaining an operation in a user registration phase of the authentication system according to the first example embodiment.

A user who desires to be provided with a service using biometric authentication performs user registration in advance. The user determines information for specifying himself/herself (user identifier (ID) and password (PW)) in the authentication system, and registers the information in the system. In the drawings including FIG. 3, the user ID is denoted by “uID”.

In addition, the user registers his/her own biometric information (e.g., a face image) in the system.

Further, the user registers his/her own activity area or living area (hereinafter referred to as an action area) in the system. For the granularity (level of detail) of the action area that can be registered in the system, various forms may be considered. For example, a country may be divided into eastern and western areas, such as Eastern Japan and Western Japan, and the eastern and western areas may be registered in the system as action areas. For example, a user whose life base (residence and workplace) is in the Kansai region registers “Western Japan” in the system as an action area.

The user registers the four pieces of information (user ID, password, biometric information, and action area) in the system using a certain means. For example, the user may mail a document describing the four pieces of information to the authentication center, and an employee of the authentication center may input the four pieces of information to the authentication server 10. Alternatively, the user may mail an external storage device such as a universal serial bus (USB) storing the four pieces of information to the authentication center.

Alternatively, the user may register biometric information, a user ID, a password, and an action area in the system by operating a terminal 40 carried by the user. Examples of the terminal 40 include mobile terminal devices, such as a smartphone, a mobile phone, a game machine, and a tablet, and computers (a personal computer and a notebook computer).

A feature amount (a feature vector including a plurality of feature amounts) used for biometrically authenticating the user is generated from a face image input to the authentication center.

In the following description, information for authenticating the user will be referred to as “user authentication information”. The user authentication information includes a user ID, a password, and biometric information (a feature amount generated from a face image).

An action area that each of the plurality of authentication servers 10 included in the authentication center is responsible for is determined in advance. In the first example embodiment, the description will be made, assuming that action areas selectable by the user are “Western Japan” and “Eastern Japan”, and the authentication server 10-1 is responsible for Western Japan as an action area and the authentication server 10-2 is responsible for Eastern Japan as an action area. In the following description, an action area that each authentication server 10 is responsible for will be referred to as “responsible area”. In the above-described example, a responsible area of the authentication server 10-1 is “Western Japan”, and a responsible area of the authentication server 10-2 is “Eastern Japan”.

It goes without saying that the above-described assignment of the action areas and the authentication servers 10 is an example, and is not intended to limit assignment of action areas and authentication servers 10. For example, in a case where Japan is divided into nine districts (Hokkaido, Tohoku, Kanto, Chubu, Kinki, Chugoku, Shikoku, Kyushu, and Okinawa) and the user can make a selection from these action areas, nine authentication servers 10 may be provided. Alternatively, the above-described nine districts may be managed by a smaller number of authentication servers 10 than nine. That is, one authentication server 10 may be responsible for a plurality of action areas.

In the authentication system according to the first example embodiment, one (hereinafter referred to as a representative server) of the plurality of authentication servers 10 can take charge of registering the user in the system. Specifically, the representative server determines a destination (authentication server 10) for storing the user authentication information of the user using the “action area” acquired from the user and the “responsible area” assigned to each authentication server 10.

For example, when the action area of the user is “Western Japan”, the authentication server 10-1 is selected as a destination for storing the user information, and when the action area of the user is “Eastern Japan”, the authentication server 10-2 is selected as a destination for storing the user information.

When the representative server determines that the destination for storing the user authentication information of the user who desires to be registered in the system is itself based on the action area and the responsible area, the representative server stores the user authentication information in an authentication information database (DB).

When the representative server determines that the destination for storing the information is another authentication server 10 based on the action area and the responsible area, the representative server transmits the user authentication information to the another authentication server 10. Acquiring the user authentication information, the authentication server 10 registers the information in its own authentication information database.

For example, when the authentication server 10-1 operates as a representative server and acquires an action area related to “Eastern Japan”, the authentication server 10-1 transmits the user authentication information to the authentication server 10-2.

When the user authentication information has been registered in the system (when the user authentication information has been registered in the database of any one of the plurality of authentication servers 10), the representative server notifies the user of “connected server information”.

As will be described later, the terminal 40 carried by the user notifies the authentication center of a current position of the user. The connected server information is information about the authentication server 10 serving as a destination to which notification of the current position is provided. For example, the connected server information is an Internet protocol (IP) address or the like of the authentication server 10 serving as a destination to which notification of the current position is provided.

The terminal 40 stores the user ID, the password, and the connected server information notification of which is provided from the representative server.

In this manner, in the user registration phase, an ID for uniquely determining a user (e.g., a user ID) in the system and biometric information used for authenticating the user are registered in the system. Note that, although it has been described as an example in the first example embodiment that a user ID and a password are used as an ID for uniquely determining a system user, the user ID can be used alone as the ID if there is no overlap in user ID between users.

### [Service Registration Phase]

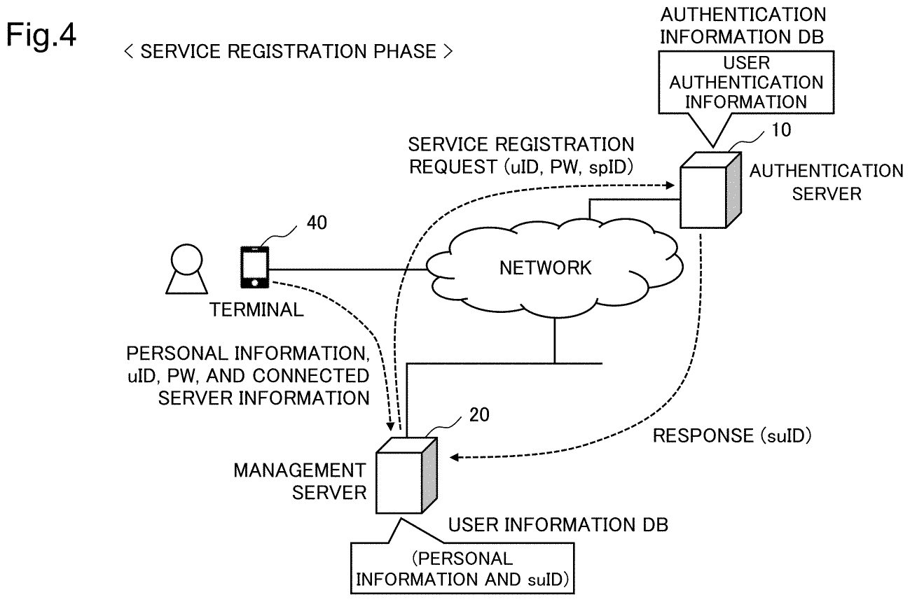

FIG. 4 is a diagram for explaining an operation in a service registration phase of the authentication system according to the first example embodiment.

The user who has completed the user registration selects a service provider from which the user wants to be provided with a service using biometric authentication, and registers the selected service provider in the system. For example, in FIG. 2, in a case where the user desires to be provided with a service from the service provider S1, the user registers the service provider S1 in the system.

The user registers personal information (e.g., name) required for being provided with a service from the selected service provider in the system. Examples of the personal information include name, age, and gender. In addition to the personal information, the user registers, in the system, the user ID and the password determined in the user registration phase, and the connected server information notification of which is provided from the system.

In the disclosure of the present application, the personal information is defined as information that does not include biometric information of the user (a person to be authenticated). That is, the biometric information and the feature amount generated from the biometric information are excluded from the “personal information” in the disclosure of the present application.

The user inputs the four pieces of information (personal information, user ID, password, and connected server information) to a service provider using a certain means. For example, the user mails a medium (paper medium or electronic medium) in which the four pieces of information are described to the selected service provider. An employee of the service provider inputs the four pieces of information to the management server 20. The user may input the four pieces of information to the management server 20 by operating the authentication terminal 30 installed in the service provider.

Alternatively, as illustrated in FIG. 4, the user may input the four pieces of information to the management server 20 by operating the terminal 40. In this case, the user inputs the four pieces of information on a webpage managed and operated by the service provider.

Upon acquiring the four pieces of information (personal information, user ID, password, and connected server information), the management server 20 transmits a “service registration request” to an authentication server 10 specified by the connected server information. Specifically, the management server 20 transmits a service registration request including a service provider ID, a user ID, and a password to the authentication server 10.

The service provider ID is identification information for uniquely identifying a service provider (a retail store or the like participating in an authentication base using biometric authentication) included in the authentication system. In the example of FIG. 2, different service provider IDs are assigned to the service providers S1 and S2, respectively.

Note that the service provider ID is an ID assigned to each service provider, and is not an ID assigned to each service. For example, in FIG. 2, even if the service providers S1 and S2 are business operators that provide the same type of service (e.g., an accommodation service), if the service providers S1 and S2 are different in management entity, different IDs are assigned to these service providers.

The authentication center and the service provider share the service provider ID by any method. For example, when a service provider participates in the authentication base, the authentication server 10 may generate a service provider ID and distribute (provide notification of) the generated service provider ID to the service provider. In the drawings including FIG. 4, the service provider ID is denoted by “spID”.

Upon receiving a service registration request, the authentication server 10 searches the authentication information database using a user ID and a password included in the request as keys, and specifies a corresponding user. Thereafter, the authentication server 10 generates a “service user ID”.

The service user ID is identification information for uniquely determining a corresponding relationship (a combination) between a user and a service provider. For example, in the example of FIG. 2, different values are set to a service user ID determined from a combination of a certain user and the service provider S1 and a service user ID determined from a combination of that user and the service provider S2, respectively.

The authentication server 10 stores a user ID, a password, a feature amount, and a service provider ID in association with the generated service user ID. That is, the authentication server 10 adds the service provider ID and the service user ID to the user authentication information stored in the authentication information database. In the drawings including FIG. 4, the service user ID is denoted by “suID”.

The authentication server 10 transmits the generated service user ID to a source from which the service registration request is transmitted. That is, the authentication server 10 transmits a response including the service user ID to the management server 20 to dispense the service user ID.

The management server 20 stores the service user ID acquired from the authentication server 10 in association with the personal information of the user. The management server 20 adds a new entry to the user information database and stores the information (personal information and service user ID).

The user repeats the registration operation as described above for each service provider from which the user wants to be provided with a service using biometric authentication. In other words, the user does not need to register the use of a service provider that provides a service that is not needed for the user.

In this manner, in the service registration phase, a service registration request including a first ID (e.g., a user ID) and a second ID (e.g., a service provider ID) is transmitted to the authentication server 10 from a service provider of a service that the user desires to use. When processing the service registration request, the authentication server 10 generates a third ID (e.g., a service user ID) uniquely determined by a combination of the user and the service provider. The authentication server 10 transmits the third ID to the service provider. The service provider (the management server 20) stores the third ID in association with the personal information of the user.

### [Service Provision Phase]

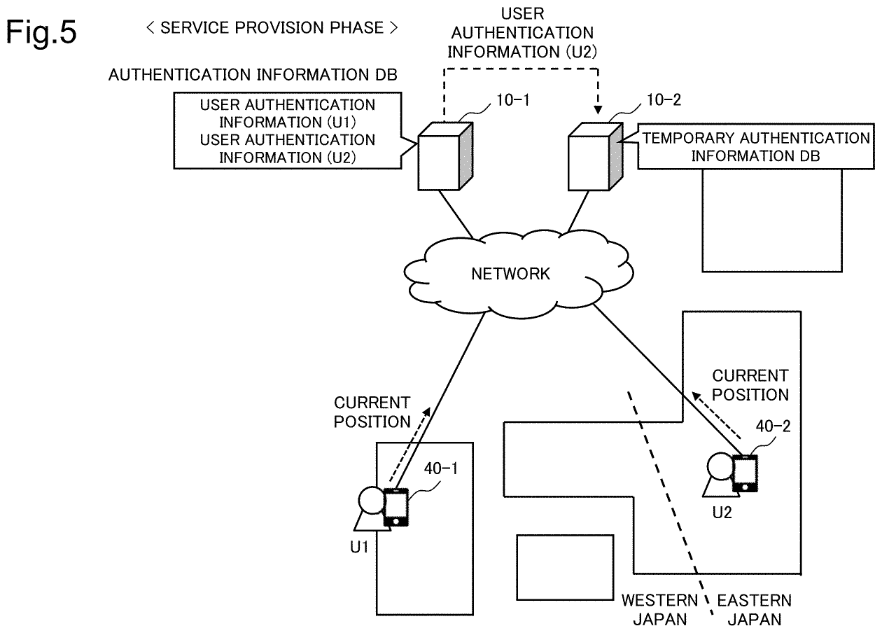

FIG. 5 is a diagram for explaining an operation in a service provision phase of the authentication system according to the first example embodiment.

When the user registration is completed, the authentication center collects a current position of each user. Specifically, the terminal 40 carried by the user notifies the authentication center of information regarding a current position (e.g., latitude and longitude) periodically or at a predetermined timing.

At this time, the terminal 40 transmits the current position to an authentication server 10 corresponding to connected server information notification of which is provided from the representative server. More specifically, the terminal 40 transmits the user ID and the password registered in the system and information including the current position (hereinafter referred to as current position information) to a connected authentication server 10. Note that, in a case where personal information or a face image is registered using an application installed in the terminal 40 carried by the user in the user registration phase, the application installed in the terminal 40 may have a function of providing notification of position information. That is, it is reasonable to notify the system of the current position of the user using the terminal 40 such as a smartphone.

Receiving the current position information, the authentication server 10 determines whether the current position of the user (the user who carries the terminal 40) belongs to its own responsible area.

When the authentication server 10 determines that the current position of the user is within its own responsible area, the authentication server 10 does not perform any particular operation. On the other hand, when the authentication server 10 determines that the current position of the user is outside its own responsible area, the authentication server 10 transmits user authentication information specified from the user ID and the password to an appropriate authentication server 10.

For example, in FIG. 5, it is assumed that both a user U1 and a user U2 select “Western Japan” as an action area. In this case, since the authentication server 10-1 is responsible for Western Japan, user authentication information of the user U1 and user authentication information of the user U2 are stored in the authentication server 10-1.

A current position of the user U1 is within Western Japan, and thus, the current position of the user U1 transmitted from a terminal 40-1 carried by the user U1 is indicated by a latitude and a longitude within Western Japan. Since an action area where the terminal 40-1 is located coincides with the responsible area of the authentication server 10-1, the authentication server 10-1 does not perform any particular operation.

On the other hand, a current position of the user U2 is within Eastern Japan, and thus, the current position of the user U2 transmitted from a terminal 40-2 carried by the user U2 is indicated by a latitude and a longitude within Eastern Japan. An action area (Eastern Japan) where the terminal 40-2 is located does not coincide with the responsible area (Western Japan) of the authentication server 10-1. Therefore, the authentication server 10-1 transmits the user authentication information (user ID, password, biometric information, service provider ID, and service user ID) of the user U2 to the authentication server 10-2 that is responsible for Eastern Japan.

The authentication server 10-2 temporarily stores the user authentication information acquired from the authentication server 10-1. Specifically, the authentication server 10-2 stores the user authentication information acquired from the authentication server 10-1 in a “temporary authentication information database”.

As described above, the terminal 40 transmits current position information to the authentication server 10 periodically or at a predetermined timing. Therefore, in the example of FIG. 5, if the user U1 moves from Western Japan to Eastern Japan, the user information of the user U1 is also temporarily stored in the authentication server 10-2.

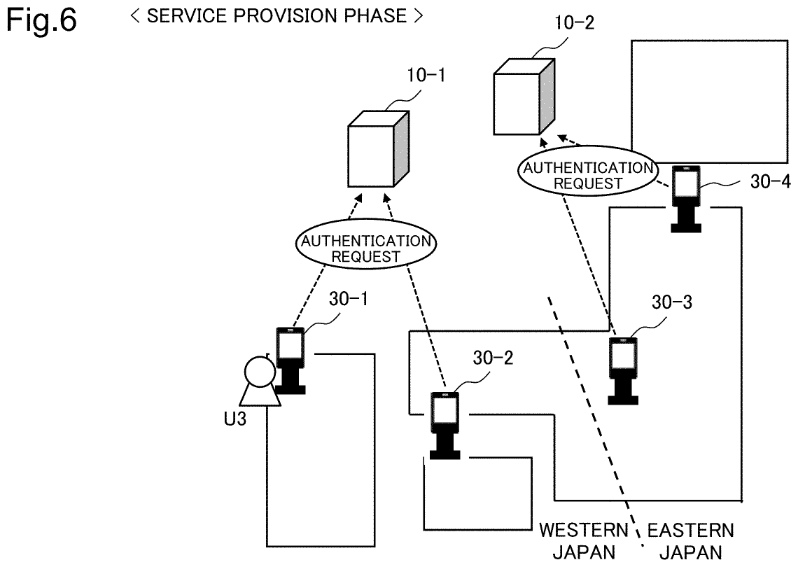

The user who has completed the service registration (service registration phase) visits a service provider. The user moves to the front of an authentication terminal 30 (see FIG. 6).

The authentication terminal 30 acquires biometric information from the user in front of the authentication terminal 30. Specifically, the authentication terminal 30 images the user and acquires a face image. The authentication terminal 30 generates a feature amount from the acquired face image. The authentication terminal 30 transmits an authentication request including the generated feature amount and the service provider ID to the authentication server 10.

Here, an authentication server 10 to which an authentication request is to be transmitted is determined in advance according to a position where the authentication terminal 30 is installed. Specifically, the authentication terminal 30 transmits an authentication request to an authentication server 10 that is responsible for the place where the authentication terminal 30 is installed.

For example, as illustrated in FIG. 6, it is assumed that authentication terminals 30-1 to 30-4 of the service provider S1 are arranged all over the country. In this case, the authentication terminals 30-1 and 30-2 installed in Western Japan transmit authentication requests to the authentication server 10-1 that is responsible for Western Japan. On the other hand, the authentication terminals 30-3 and 30-4 installed in Eastern Japan transmit authentication requests to the authentication server 10-2 that is responsible for Eastern Japan.

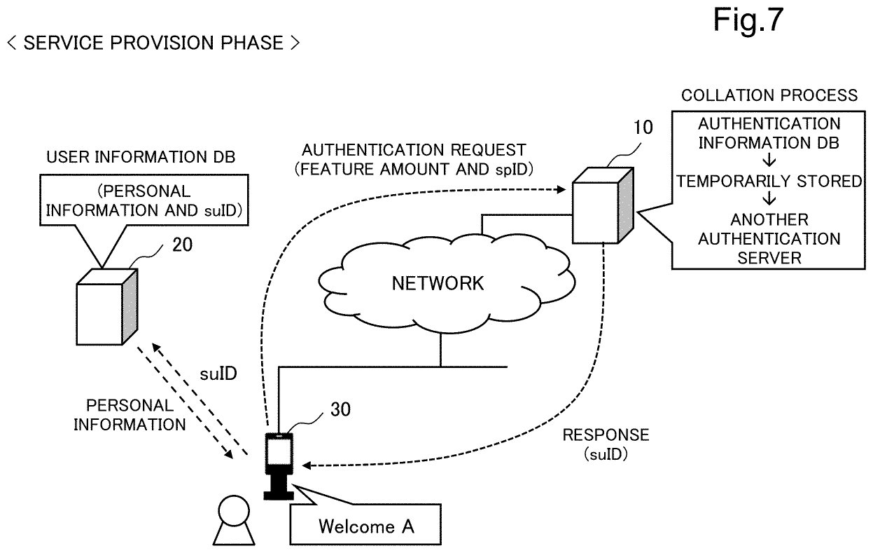

When receiving the authentication request, the authentication server 10 processes the authentication request acquired from the authentication terminal 30 using an authentication information database constructed therein (see FIG. 7). Specifically, the authentication server 10 extracts the feature amount from the authentication request, and executes collation processes (one-to-N collation; N is a positive integer, and the same applies hereinafter) in a state where the extracted feature amount is set on a collation side and each of the feature amounts stored in the databases is set on a registration side.

When the collation process has failed, the authentication server 10 processes the authentication request acquired from the authentication terminal 30 using the temporarily stored user authentication information (user authentication information acquired from another authentication server 10).

When the collation process using the temporarily stored user authentication information has also failed, the authentication server 10 requests another authentication server 10 to process the authentication request. Specifically, the authentication server 10 transfers the acquired authentication request to another authentication server 10, and requests the another authentication server 10 to process the authentication request.

For example, in the example of FIG. 6, it is assumed that the authentication terminal 30-1 transmits an authentication request related to a user U3 to the authentication server 10-1.

In this case, the authentication server 10-1 processes the acquired authentication request using user authentication information stored in itself. If an action area registered in the system by the user U3 is “Western Japan”, the user authentication information of the user U3 is stored in the authentication server 10-1. In this case, the authentication of the user U3 succeeds in an initial collation process (a collation process using information stored in the authentication information database of the authentication server 10-1).

However, the user U3 may move to Western Japan on a business trip or the like, while an action area of the user U3 is “Eastern Japan”. In such a case, since the user authentication information of the user U3 is stored in the authentication server 10-2, the initial collation process fails. Here, if the user U3 carries the terminal 40 while moving, the user authentication information of the user U3 is copied to the authentication server 10-1 according to the movement of the user U3. Therefore, when the authentication server 10-1 executes a collation process using the temporarily stored user authentication information, the authentication of the user U3 succeeds in the collation process using the temporarily stored user authentication information.

However, the user U3 may move from Eastern Japan to Western Japan while not carrying the terminal 40. In this case, the user authentication information of the user U3 does not exist in the authentication server 10-1. Therefore, the authentication of the user U3 may also fail in a second-stage collation process. In this case, the authentication server 10-1 transmits the authentication request acquired from the authentication terminal 30-1 to another authentication server (the authentication server 10-2), and requests the another authentication server to process the authentication request. Since the authentication server 10-2 stores the user authentication information of the user U3, the authentication of the user U3 succeeds in a last collation process (a third-stage collation process).

In all of the first-stage to third-stage collation processes, the authentication server 10 executes the collation processes in a state where the feature amount included in the authentication request is set on the collation side and each of the feature amounts stored as the user authentication information in the databases is set on the registration side. The authentication server 10 specifies a user through the collation process, and specifies a service user ID corresponding to the service provider ID included in the authentication request among a plurality of service user IDs associated with the specified user.

The authentication server 10 transmits the specified service user ID to a source from which the authentication request is transmitted (see FIG. 7). The authentication server 10 transmits a response (a response to the authentication request) including the specified service user ID to the authentication terminal 30.

When receiving the response to the authentication request from the authentication server 10, the authentication terminal 30 extracts the service user ID from the response. The authentication terminal 30 transmits the service user ID to the management server 20.

The management server 20 searches the user information database using the acquired service user ID as a key, and specifies personal information corresponding to the service user ID. The management server 20 transmits the specified personal information to the authentication terminal 30. The authentication terminal 30 provides a service using the acquired personal information.

In this manner, in the service provision phase, the authentication server 10 receives an authentication request including biometric information of the user and a second ID (a service provider ID) from a service provider. The authentication server 10 specifies a third ID (a service user ID) using the biometric information of the user and the second ID. The authentication server 10 transmits the specified third ID to the service provider. When providing the user with a service, the service provider specifies personal information of the user using the third ID acquired by transmitting the authentication request to the authentication server 10. The service provider provides the user with the service using the specified personal information.

Next, each of the devices included in the authentication system according to the first example embodiment will be described in detail.

### [Authentication Server]

Each of the plurality of authentication servers 10 included in the authentication system stores, in an authentication information database (a first database), user authentication information for performing authentication using biometric information for some of a plurality of users. Each authentication server 10 processes an authentication request received from the authentication terminal 30 using the user authentication information stored in the first database.

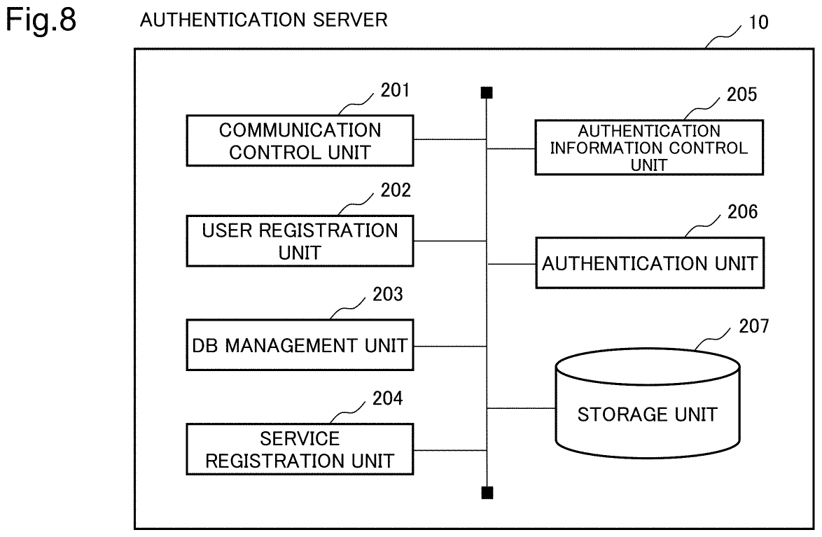

FIG. 8 is a diagram illustrating an example of a processing configuration (processing modules) of the authentication server 10 according to the first example embodiment. Referring to FIG. 8, the authentication server 10 includes a communication control unit 201, a user registration unit 202, a database management unit 203, a service registration unit 204, an authentication information control unit 205, an authentication unit 206, and a storage unit 207.

The communication control unit 201 is a means for controlling communication with another device. For example, the communication control unit 201 receives data (packet) from the management server 20. Also, the communication control unit 201 transmits data to the management server 20. The communication control unit 201 delivers data received from another device to another processing module. The communication control unit 201 transmits data acquired from another processing module to another device. In this manner, another processing module transmits and receives data to and from another device via the communication control unit 201.

The user registration unit 202 is a means for enabling the above-described user registration. The user registration unit 202 acquires a user ID, a password, biometric information (a face image), and an action area of a user (a user who desires to be provided with a service using biometric authentication; a system user).

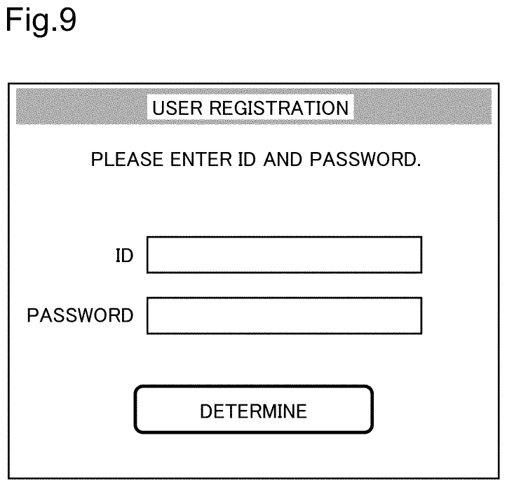

The user registration unit 202 acquires the four pieces of information (user ID, password, biometric information, and action area) using a certain means. For example, the user registration unit 202 displays a graphical user interface (GUI) or a fill-in form for determining a user ID and a password on the terminal 40. For example, the user registration unit 202 displays a GUI as illustrated in FIG. 9 on the terminal 40.

The user registration unit 202 verifies whether the user ID and the password acquired through the GUI or the like do not overlap with the already registered user ID and password. When there is no overlap, the user registration unit 202 displays a GUI for acquiring biometric information and an action area of the user on the terminal 40.

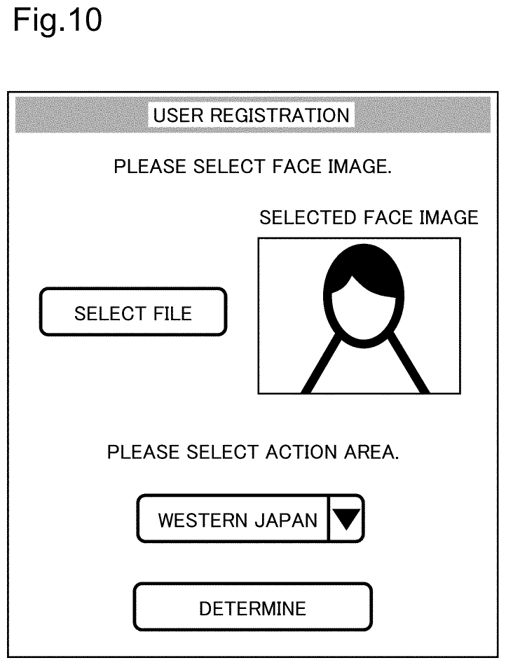

For example, the user registration unit 202 displays a GUI as illustrated in FIG. 10 on the terminal 40. For example, the user presses a “select file” button illustrated in FIG. 10 to designate a face image to be registered in the system as image data. The designated face image is displayed in a preview area (displayed as a selected face image in FIG. 10).

In addition, the user selects an “action area” based on a home, a workplace, or the like. When the selection of the face image and the action area is completed, the user presses an “enter” button.

For example, when acquiring the user ID, the password, the biometric information (face image), and the action area through the GUIs as illustrated in FIGS. 9 and 10, the user registration unit 202 generates a feature amount (a feature vector including a plurality of feature amounts) from the face image.

Specifically, the user registration unit 202 extracts feature points from the acquired face image. Concerning a process of extracting feature points, a conventional technique can be used, and thus, the detailed description thereof will be omitted. For example, the user registration unit 202 extracts an eye, a nose, a mouth, and the like as feature points from the face image. Thereafter, the user registration unit 202 calculates a position of each of the feature points and a distance between the feature points as feature amounts, and generates a feature vector (vector information characterizing the face image) including the plurality of feature amounts.

When the authentication server 10 operates as a “representative server”, the user registration unit 202 determines an authentication server 10 that stores the user authentication information based on the acquired action area and the responsible area assigned to each server.

Specifically, when the acquired action area is included in the responsible area of the representative server, the user registration unit 202 determines the user authentication information of the user registered in the system as user authentication information managed by the representative server. When the acquired action area is not included in the responsible area of the representative server, the user registration unit 202 determines the user authentication information of the user registered in the system as user authentication information managed by another authentication server 10.

When the user authentication information of the user registered in the system is determined as user authentication information stored in itself (the representative server), the user registration unit 202 delivers the user authentication information (user ID, password, and feature amount) to the database management unit 203.

When the user authentication information of the user registered in the system is determined as user authentication information stored in another authentication server 10, the user registration unit 202 transmits the user authentication information to the another authentication server 10. At this time, the user registration unit 202 may grasp a destination to which the user authentication information is to be transmitted, referring to a list (table information) in which relationships between responsible areas and corresponding authentication servers 10 are described.

When the user registration is completed, the user registration unit 202 notifies the terminal 40 of connected server information. When the user authentication information is stored in the representative server, the user registration unit 202 notifies the terminal 40 of an IP address and the like of the representative server. When the user authentication information is stored in a server other than the representative server, the user registration unit 202 notifies the terminal 40 of an IP address or the like of the another authentication server 10.

The database management unit 203 is a means for managing the authentication information database. The authentication information database stores information for specifying a system user (user ID and password), biometric information of the user (feature amount), a service provider ID for specifying a service provider, and a service user ID for specifying the user in each service in association with each other.

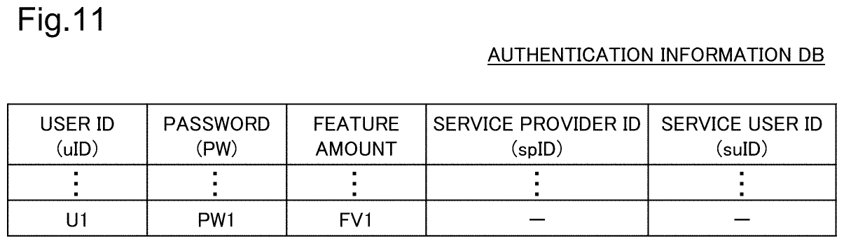

When acquiring three pieces of information (user ID, password, and feature amount) from the user registration unit 202 or another authentication server 10, the database management unit 203 adds a new entry to the authentication information database. For example, when acquiring the above-described three pieces of information about the user U1, the database management unit 203 adds an entry illustrated at the lower end of FIG. 11. In the user registration phase, since a service provider ID and a service user ID are not generated, nothing is set in the fields therefor.

The service registration unit 204 is a means for enabling a system user to register an individual service. The service registration unit 204 processes a service registration request acquired from the management server 20 of the service provider.

The service registration unit 204 searches the authentication information database using a user ID and a password included in the acquired service registration request as keys. The service registration unit 204 checks a service provider ID field of the specified user (the user specified from a set of the user ID and the password).

The service registration unit 204 determines whether the service provider ID included in the service registration request acquired from the management server 20 is set in the service provider ID field. When the service provider ID acquired from the management server 20 has already been registered in the database, the service registration unit 204 notifies the management server 20 of the fact. In this case, since the service (service provider) to be registered by the user has already been registered in the authentication information database, the service registration unit 204 transmits a “negative response” as a response to the service registration request.

On the other hand, when the service provider ID included in the service registration request is not set in the service provider ID field of the specified user, the service registration unit 204 generates a service user ID corresponding to the user and the service provider.

As described above, a service user ID is identification information uniquely determined from a combination of a user and a service provider. For example, the service registration unit 204 calculates a hash value using the user ID, the password, and the service provider ID, and sets the calculated hash value as a service user ID. Specifically, the service registration unit 204 generate a service user ID by calculating a concatenated value of the user ID, the password, and the service provider ID, and calculating a hash value of the calculated concatenated value.

Note that the generation of the service user ID using the hash value is an example and is not intended to limit a method of generating the service user ID. The service user ID may be any information as long as the information is capable of uniquely identifying a combination of a system user and a service provider. For example, whenever processing a service registration request, the service registration unit 204 may assign a unique value as a service user ID.

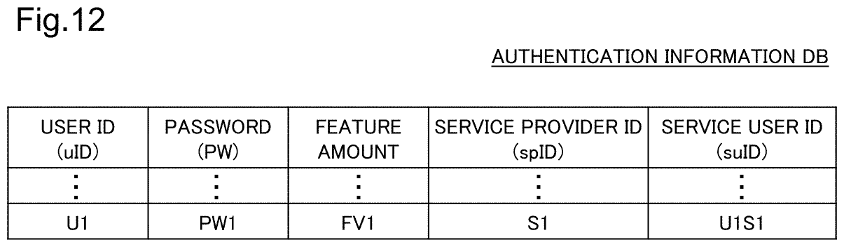

When generating the service user ID, the service registration unit 204 delivers the service provider ID and the service user ID to the database management unit 203 together with the user ID and the password. The database management unit 203 registers two IDs (service provider ID and service user ID) in the authentication information database. For example, when the user U1 registers a service for the service provider S1, the above-described two IDs are added to an entry illustrated at the lower end of FIG. 12.

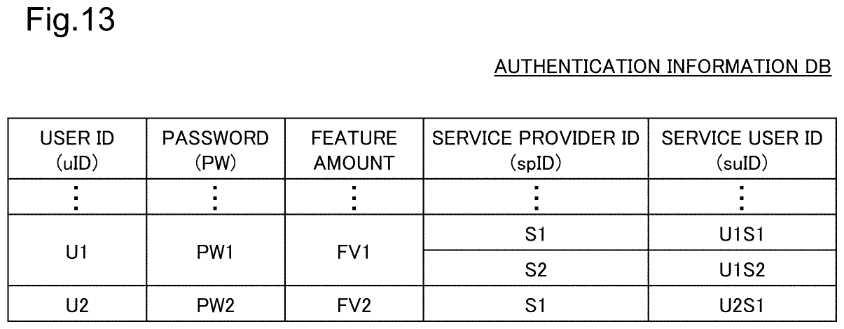

Since service registration is performed for each service provider, a plurality of service providers and a plurality of service user IDs may be set for one user. For example, in a case where the user U1 performs service registration for each of the service providers S1 and S2, the entries of the second and third lines of FIG. 13 are generated. In a case where the user U2 performs service registration for the service provider S1, an entry is generated as illustrated at the lower end of FIG. 13.

The authentication information database illustrated in FIG. 13, etc. is an example, and is not intended to limit information stored in the authentication information database. For example, instead of the feature amount for authentication, a face image may be registered in the authentication information database. That is, a feature amount may be generated from the face image registered in the authentication information database whenever authentication is performed.

When the service provider ID and the service user ID are registered in the authentication information database, the service registration unit 204 notifies the management server 20 that the service registration request has been normally processed. The service registration unit 204 transmits a “positive response” as a response to the service registration request. At this time, the service registration unit 204 transmits the response including the service user ID to the management server 20.

The authentication information control unit 205 is a means for controlling the transfer (copy) of user authentication information. The authentication information control unit 205 acquires “current position information” from the terminal 40 carried by the user. The authentication information control unit 205 determines whether the user is located within the responsible area of the corresponding authentication server, referring to a current position of the user included in the current position information. For example, in a case where the current position is indicated by a latitude and a longitude, the authentication information control unit 205 makes the above-described determination based on whether the latitude and the longitude are within the range of the responsible area.

The authentication information control unit 205 does not perform any particular operation, when it is determined that the user who has transmitted the current position information exists in the responsible area of the corresponding authentication server.

The authentication information control unit 205 transmits the user authentication information of the user to another authentication server 10, when it is determined that the user who has transmitted the current position information exists outside the responsible area of the corresponding authentication server. Specifically, the authentication information control unit 205 determines which authentication server 10 is responsible for the current position of the user. The authentication information control unit 205 specifies a responsible area including the current position (latitude and longitude) of the user, and transmits the user authentication information to an authentication server 10 that is responsible for the specified area. When specifying the responsible area, the authentication information control unit 205 refers to each server and a list in which a responsible area (a range of the responsible area) of each server is defined.

When receiving user authentication information from another authentication server 10, the authentication information control unit 205 temporarily stores the user authentication information. Specifically, the authentication information control unit 205 adds the acquired user authentication information to the temporary authentication information database. At this time, the authentication information control unit 205 also manages a date and time when an entry is added to the database.

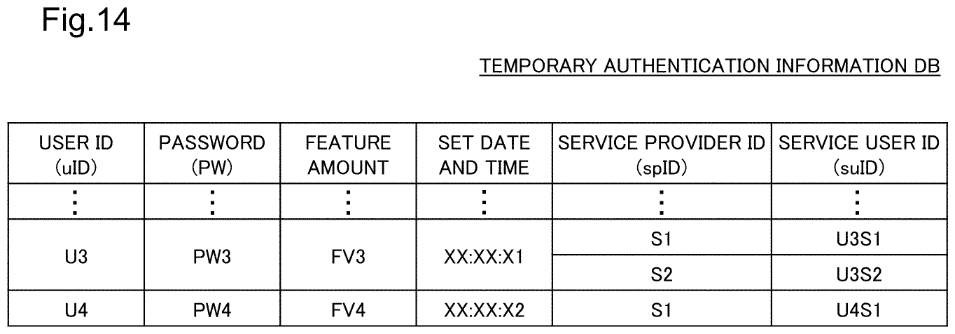

FIG. 14 is a diagram illustrating an example of a temporary authentication information database. The authentication information control unit 205 deletes an entry for which a predetermined time period (e.g., one week) has elapsed since the entry was added, periodically referring to the temporary authentication information database.

Note that the temporary authentication information database illustrated in FIG. 14 is an example, and a time to live (TTL) field may be provided instead of the set date and time field. When adding an entry to the database, the authentication information control unit 205 sets a valid period (e.g., one week) of the entry. The TTL field is updated over time, and at a timing when a value of the TTL field becomes “0”, a corresponding entry is deleted.

When receiving the user information of the user stored in the temporary authentication information database, the authentication information control unit 205 may update the entry in the database according to the received user information.

The authentication unit 206 is a means for performing a process of authenticating a system user. As described above, the authentication unit 206 processes an authentication request from the authentication terminal 30 in a predetermined collating sequence.

First, the authentication unit 206 processes the authentication request by performing a collation process using the user authentication information stored in the authentication information database of the corresponding authentication server.

When the authentication has failed in the collation process (first-stage collation process), the authentication unit 206 processes the authentication request by performing a collation process using the user authentication information stored in the temporary authentication information database of the corresponding authentication server.

When the authentication has failed in the second-stage collation process, the authentication unit 206 requests another authentication server 10 to process the authentication request. In this case, the authentication unit 206 transfers the authentication request to the another authentication server 10.

In a case where the system is operated with two authentication servers 10 as illustrated in FIG. 2, the authentication unit 206 may transmit (unicast) an authentication request to the authentication server 10 other than the corresponding authentication server. Alternatively, in a case where the system is operated with three or more authentication servers 10, the authentication unit 206 may transmit (broadcast) an authentication request to each of the other authentication servers 10.

Basically, the above-described three collation processes are similarly performed by the authentication unit 206.

The authentication unit 206 extracts the feature amount and the service provider ID included in the authentication request. The authentication unit 206 searches the databases (authentication information database and temporary authentication information database) using the extracted feature amount and service provider ID as keys, and specifies a corresponding service user ID.

The authentication unit 206 executes one-to-N collation in a state where the feature amount extracted from the authentication request is set as a feature amount on the collation side and each of the feature amounts stored in the databases is set as a feature amount on the registration side. Specifically, the authentication unit 206 calculates a degree of similarity between the feature amount on the collation side and each of the plurality of feature amounts on the registration side. The degree of similarity can be calculated using a Chi-square distance, a Euclidean distance, or the like. The degree of similarity is lower as the distance is larger, and the degree of similarity is higher as the distance is smaller.

The authentication unit 206 determines whether there is a feature amount having a highest degree of similarity while having a degree of similarity equal to or greater than a predetermined value with respect to the feature amount to be collated, among the plurality of feature amounts registered in the database. When there is such a feature amount, the authentication unit 206 determines whether there is an entry matching the service provider ID included in the authentication request, among one or more service provider IDs associated with the user specified by the one-to-N collation.

When there is such an entry as described above (when the above-described two determinations have succeeded), the authentication unit 206 determines that the authentication of the user has succeeded.

When at least one of the above-described two determinations has failed the authentication unit 206 determines that the authentication of the user has failed.

When the authentication has succeeded, the authentication unit 206 transmits a “positive response” to a source from which the authentication request is transmitted (the authentication terminal 30 or another authentication server 10). At this time, the authentication unit 206 generates a response (a response to the authentication request) including a service user ID of the specified entry, and transmits the response to the source from which the authentication request is transmitted.

When the authentication has failed, the authentication unit 206 transmits a “negative response” to the source from which the authentication request is transmitted.

For example, in the example of FIG. 13, in a case where “FV1” as a feature amount and “S1” as a service provider ID are included in the authentication request, the entries (users) of the second and third lines are specified by the feature amount FV1, and the entry of the second line is specified by the service provider ID “S1”. As a result, the authentication request is processed normally, and a positive response including “U1S1” as a service user ID is transmitted to the source from which the authentication request is transmitted (the authentication terminal 30 or another authentication server 10).

On the other hand, in a case where “FV2” as a feature amount and “S2” as a service provider ID are included in the authentication request, an entry illustrated at the lower end of FIG. 13 is specified by the feature amount, but the service provider ID of the specified entry is not “S2” but “S1”. As a result, the authentication request is not normally processed. Accordingly, a negative response is transmitted to the source from which the authentication request is transmitted.

When authentication using the user authentication information stored in the authentication information database has failed as described above, the authentication unit 206 processes the authentication request using the user authentication information stored in the temporary authentication information database. Further, when authentication using the user authentication information stored in the temporary authentication information database has failed, the authentication unit 206 requests another authentication server 10 to process the authentication request from the authentication terminal 30.

The storage unit 207 stores information required for operating the authentication server 10. In the storage unit 207, the authentication information database and the temporary authentication information database are constructed. The authentication information database is a first database that stores user authentication information for users whose action areas are included in a responsible area assigned to the corresponding authentication server among a plurality of users. The temporary authentication information database is a second database that temporarily stores the user information stored in the authentication information database (first database) included in the authentication server 10.

### [Management Server]

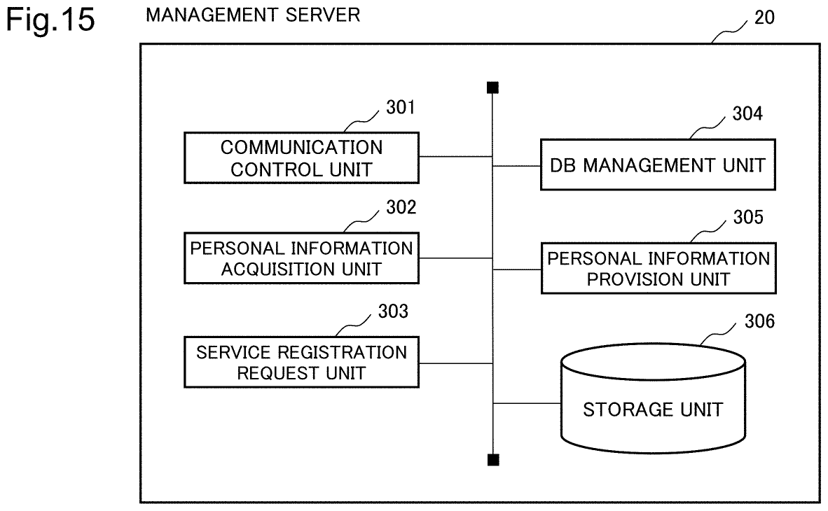

FIG. 15 is a diagram illustrating an example of a processing configuration (processing modules) of the management server 20 according to the first example embodiment. Referring to FIG. 15, the management server 20 includes a communication control unit 301, a personal information acquisition unit 302, a service registration request unit 303, a database management unit 304, a personal information provision unit 305, and a storage unit 306.

The communication control unit 301 is a means for controlling communication with another device. For example, the communication control unit 301 receives data (packet) from the authentication server 10 and the authentication terminal 30. In addition, the communication control unit 301 transmits data to the authentication server 10 and the authentication terminal 30. The communication control unit 301 delivers data received from another device to another processing module. The communication control unit 301 transmits data acquired from another processing module to another device. In this manner, another processing module transmits and receives data to and from another device via the communication control unit 301.

The personal information acquisition unit 302 is a means for acquiring personal information required when a service provider provides a service. For example, in a case where the service provider is a “retail store”, the personal information acquisition unit 302 acquires information regarding payment (e.g., credit card information or bank account information) in addition to a user's name and the like. Alternatively, in a case where the service provider is a “hotel business operator”, the personal information acquisition unit 302 acquires reservation information regarding accommodation (e.g., an accommodation date) in addition to a name and the like.

In addition to the personal information such as the name, the personal information acquisition unit 302 acquires the user ID and the password determined by the user at the time of registering the user in the system and the connected server information notification of which is provided from the system.

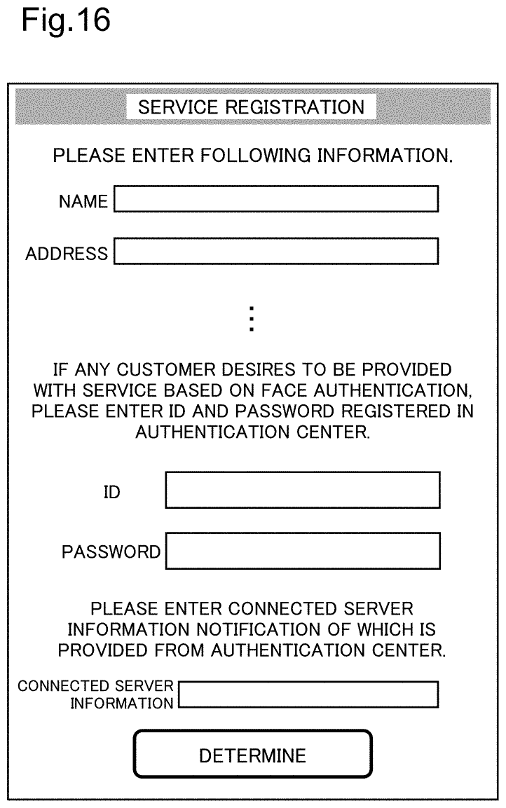

The personal information acquisition unit 302 acquires the personal information, the user ID, the password, and the connected server information using a certain means. For example, the personal information acquisition unit 302 displays a GUI or a form for inputting the above-described information on the terminal 40 (see FIG. 16). Alternatively, information as illustrated in FIG. 16 may be displayed on a web page managed and operated by a service provider. Alternatively, the terminal 40 may download an application provided by a service provider, and information as illustrated in FIG. 16 may be displayed through the application. In particular, the web page may be a web page for managing member information of the service provider. That is, a member of each service provider may register a service on the web page for managing his/her member information.

The personal information acquisition unit 302 delivers the personal information, the user ID, the password, and the connected server information acquired using the GUI or the like to the service registration request unit 303.

The service registration request unit 303 is a means for requesting the authentication server 10 to register the service use of the user.

The service registration request unit 303 selects the user ID and the password from the four pieces of information (personal information, user ID, password, and connected server information) acquired from the personal information acquisition unit 302. The service registration request unit 303 transmits a service registration request including a service provider ID together with the selected user ID and password to an authentication server 10 designated by the connected server information.

The service registration request unit 303 acquires a response to the service registration request from the authentication server 10. When the acquired response is a “negative response”, the service registration request unit 303 notifies the user of the fact. For example, the service registration request unit 303 notifies the user that the service registration has already been performed.

When the acquired response is a “positive response”, the service registration request unit 303 notifies the user that the service registration has succeeded. In addition, the service registration request unit 303 delivers, to the database management unit 304, a service user ID included in the response and the personal information acquired from the personal information acquisition unit 302.

The database management unit 304 is a means for managing the user information database. The user information database is a database for managing information about users (system users) to be provided with a service. The user information database stores the personal information (e.g., name) of the user in association with the service user ID acquired from the authentication server 10.

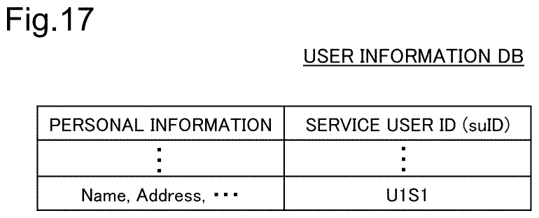

When acquiring the above-described information (personal information and service user ID) from the service registration request unit 303, the database management unit 304 adds a new entry to the user information database. For example, in a case where the management server 20 of the service provider S1 acquires the above-described information about the user U1, an entry illustrated at the lower end of FIG. 17 is added.

The personal information provision unit 305 is a means for providing the authentication terminal 30 with “personal information” in response to a request from the authentication terminal 30.

The personal information provision unit 305 acquires the service user ID from the authentication terminal 30. The personal information provision unit 305 searches the user information database using the service user ID as a key, and specifies corresponding personal information. For example, in the example of FIG. 17, if the service user ID is “U1S1”, the personal information illustrated at the lower end of FIG. 17 is transmitted to the authentication terminal 30.

The personal information provision unit 305 transmits the specified personal information to the authentication terminal 30.

The storage unit 306 stores information required for operating the management server 20. The user information database is constructed in the storage unit 306.

### [Authentication Terminal]

The authentication terminal 30 transmits an authentication request including biometric information of a user to a predetermined authentication server 10 among the plurality of authentication servers 10. More specifically, the authentication terminal 30 transmits an authentication request to an authentication server 10 that is responsible for the place where the authentication terminal 30 is installed among the plurality of authentication servers 10. The authentication terminal 30 acquires personal information of the user from the management server 20 by transmitting a service user ID acquired from the authentication server 10 to the management server 20. The authentication terminal 30 provides the user with a service using the acquired personal information.

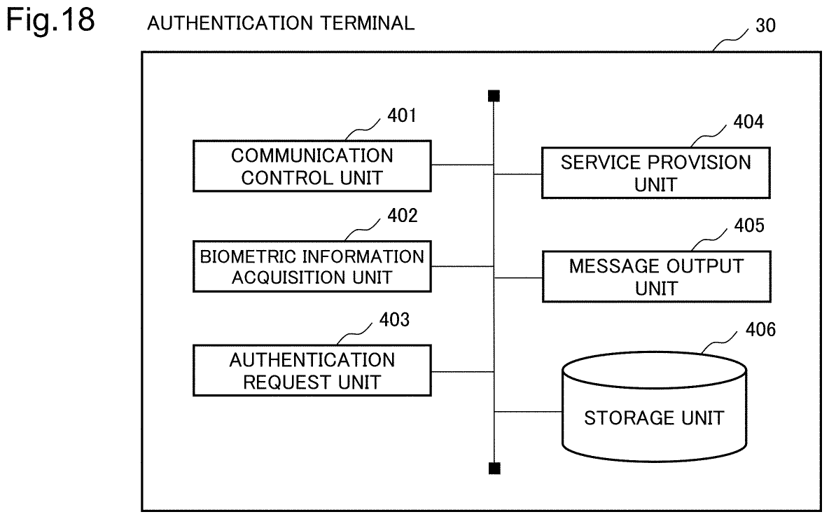

FIG. 18 is a diagram illustrating an example of a processing configuration (processing modules) of the authentication terminal 30 according to the first example embodiment. Referring to FIG. 18, the authentication terminal 30 includes a communication control unit 401, a biometric information acquisition unit 402, an authentication request unit 403, a service provision unit 404, a message output unit 405, and a storage unit 406.

The communication control unit 401 is a means for controlling communication with another device. For example, the communication control unit 401 receives data (packet) from the management server 20. Also, the communication control unit 401 transmits data to the management server 20. The communication control unit 401 delivers data received from another device to another processing module. The communication control unit 401 transmits data acquired from another processing module to another device. In this manner, another processing module transmits and receives data to and from another device via the communication control unit 401.

The biometric information acquisition unit 402 is a means for acquiring biometric information (a face image) of a user by controlling a camera. The biometric information acquisition unit 402 captures an image in front of itself periodically or at a predetermined timing. The biometric information acquisition unit 402 determines whether a face image of a person is included in the acquired image, and extracts the face image from the acquired image data when the face image is included.

Concerning a process of detecting or extracting a face image by the biometric information acquisition unit 402, a conventional technique can be used, and thus, the detailed description thereof will be omitted. For example, the biometric information acquisition unit 402 may extract a face image (face area) from the image data using a learning model trained by a convolutional neural network (CNN). Alternatively, the biometric information acquisition unit 402 may extract a face image using a template matching method or the like.

The biometric information acquisition unit 402 delivers the extracted face image to the authentication request unit 403.

The authentication request unit 403 is a means for requesting the authentication server 10 to authenticate a user.

When acquiring the biometric information (face image) from the biometric information acquisition unit 402, the authentication request unit 403 generates a feature amount from the face image. The authentication request unit 403 transmits an authentication request including the generated feature amount and the service provider ID to the authentication server 10. The service provider ID is distributed from the authentication center via the management server 20.

When a response from the authentication server 10 is a “negative response” (when the authentication has failed), the authentication request unit 403 notifies the user of the fact via the message output unit 405.

When a response from the authentication server 10 is a “positive response” (when the authentication has succeeded), the authentication request unit 403 extracts a service user ID included in the response from the authentication server 10. The authentication request unit 403 delivers the extracted service user ID to the service provision unit 404.

The service provision unit 404 is a means for providing a user with a predetermined service. The service provision unit 404 transmits the service user ID acquired from the authentication request unit 403 to the management server 20. The management server 20 replies with personal information (e.g., name) corresponding to the service user ID. The service provision unit 404 provides the user with a service using the personal information received as a reply.

The message output unit 405 is a means for outputting various kinds of messages to users. For example, the message output unit 405 outputs a message regarding a result of authenticating a user or a message regarding providing a service. The message output unit 405 may display a message using a display device such as a liquid crystal monitor, or may reproduce a voice message using an acoustic device such as a speaker.

The storage unit 406 stores information required for operating the authentication terminal 30.

### [Terminal]

The terminal 40 transmits current position information including its current position (a user's current position) to an authentication server 10 determined according to an action area of the user among the plurality of authentication servers 10.

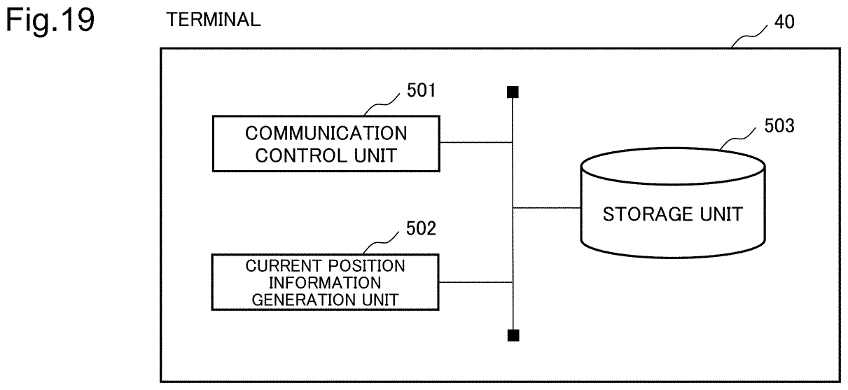

FIG. 19 is a diagram illustrating an example of a processing configuration (processing modules) of the terminal 40 according to the first example embodiment. Referring to FIG. 19, the terminal 40 includes a communication control unit 501, a current position information generation unit 502, and a storage unit 503.

The communication control unit 501 is a means for controlling communication with another device. For example, the communication control unit 501 receives data (packet) from the authentication server 10 and the management server 20. In addition, the communication control unit 501 transmits data to the authentication server 10 and the management server 20. The communication control unit 501 delivers data received from another device to another processing module. The communication control unit 501 transmits data acquired from another processing module to another device. In this manner, another processing module transmits and receives data to and from another device via the communication control unit 501.

The current position information generation unit 502 is a means for generating current position information (information including a user ID, a password, and a current position).

The current position information generation unit 502 measures a current position using a certain means. For example, the current position information generation unit 502 executes position measurement to calculate a current position (latitude and longitude) of the terminal 40 by receiving a global positioning system (GPS) signal from a GPS satellite. Alternatively, the current position information generation unit 502 may calculate a current position by using information (information on a position of a base station, a radio wave intensity, etc.) obtained from a wireless base station or a wireless access point.

The current position information generation unit 502 calculates a current position periodically or at a predetermined timing, and transmits current position information including the calculated current position, the user ID, and the password to the authentication server 10. The destination to which the current position information is transmitted is an authentication server 10 indicated by the connected server information notification of which is provided from the authentication center.

The storage unit 503 stores information required for operating the terminal 40.

A processing module in a case where user registration or service registration is performed using the terminal 40 is obvious to those skilled in the art, and thus, the description thereof will be omitted.

### [Operation of System]

Next, an operation of the authentication system according to the first example embodiment will be described. The operation of the authentication system will be described with respect to the service registration phase and the service provision phase, and the description of the user registration phase will be omitted.

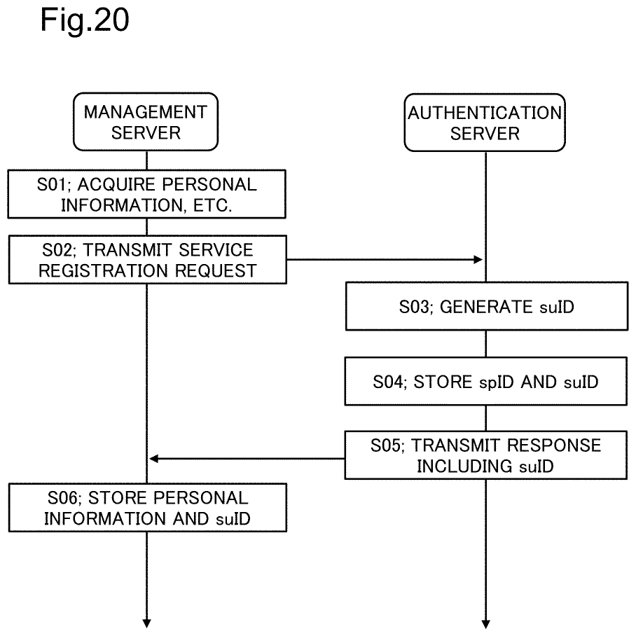

FIG. 20 is a sequence diagram illustrating an example of the operation of the authentication system related to the service registration phase according to the first example embodiment.

The management server 20 acquires personal information (information required for providing a service), a user ID, a password, and connected server information from a user (step S01).

The management server 20 transmits a service registration request including a service provider ID together with the acquired user ID and password to the authentication server 10 (step S02).

The authentication server 10 generates a service user ID using the acquired user ID, password, and service provider ID (step S03).

The authentication server 10 stores the service provider ID and the service user ID in the authentication information database (step S04).

The authentication server 10 transmits a response (a response to the service registration request) including the service user ID to the management server 20 (step S05).

The management server 20 stores the personal information acquired in the step S01 and the service user ID acquired from the authentication server 10 in association with each other in the user information database (step S06).

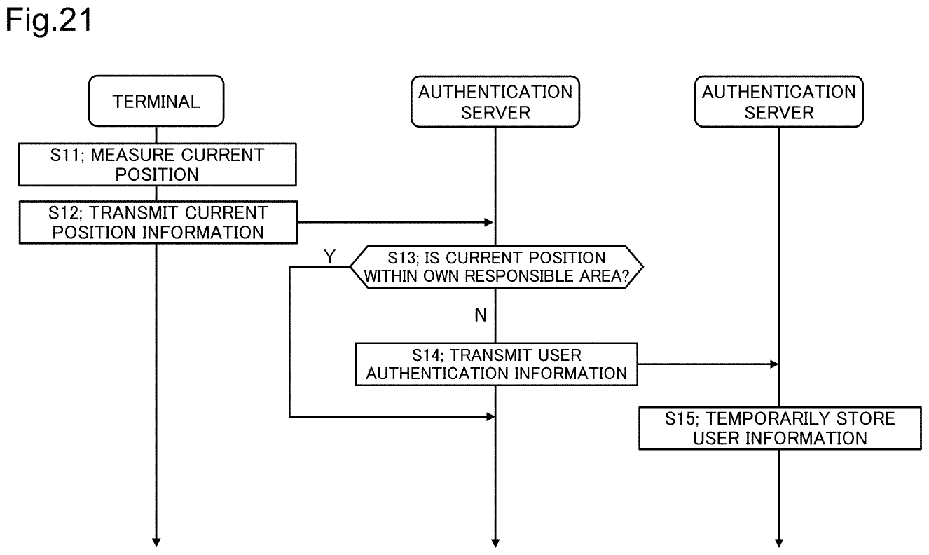

FIG. 21 is a sequence diagram illustrating an example of the operation of the authentication system related to the service provision phase according to the first example embodiment. An operation related to processing current position information transmitted from the terminal 40 will be described with reference to FIG. 21.

The terminal 40 measures (calculates) a current position periodically or at a predetermined timing (step S11).

The terminal 40 transmits current position information including the measured current position to an authentication server 10 notification of which is provided from the authentication center (step S12).

Acquiring the current position information, the authentication server 10 determines whether the current position of the user (terminal 40) is within its own responsible area (step S13).

When the current position is within its own responsible area (Yes in the step S13), the authentication server 10 does not perform any particular operation.

When the current position is outside its own responsible area (No in the step S13), the authentication server 10 transmits user authentication information corresponding to the source from which the current position information is transmitted to another authentication server 10 (step S14). Specifically, the authentication server 10 specifies user authentication information corresponding to a person (user) carrying the terminal 40 which has transmitted the current position information, using the user ID and the password included in the current position information. The authentication server 10 specifies a destination to which the user authentication information is to be transmitted, referring to a current position of the terminal 40 and a list in which a responsible area of each server is defined.

The authentication server 10 transmits the specified user authentication information to an authentication server 10 whose responsible area includes the current position of the user.

The authentication server 10 receiving the user authentication information temporarily stores the information (step S15). Specifically, the authentication server 10 stores the acquired user authentication information in the temporary authentication information database.

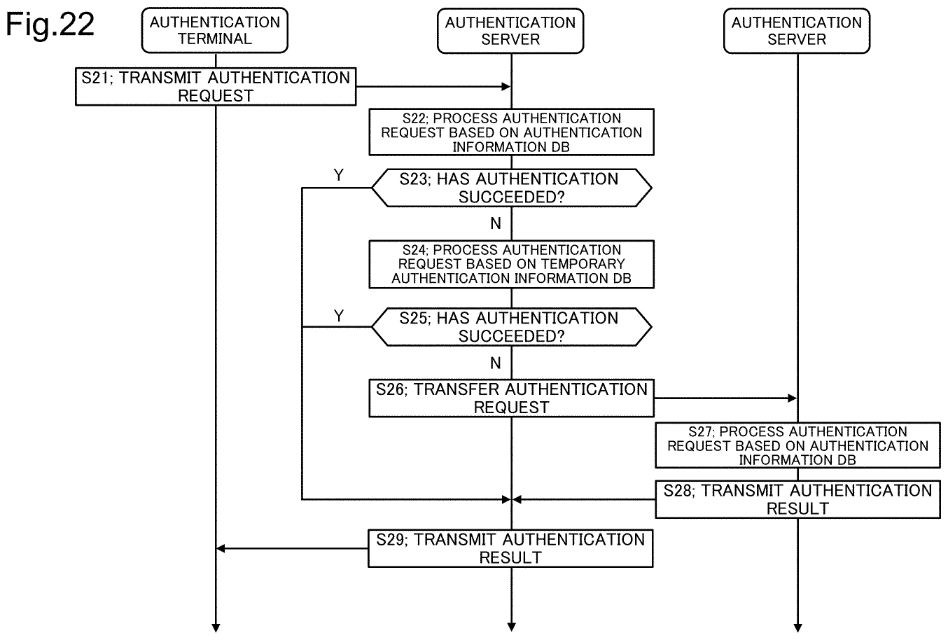

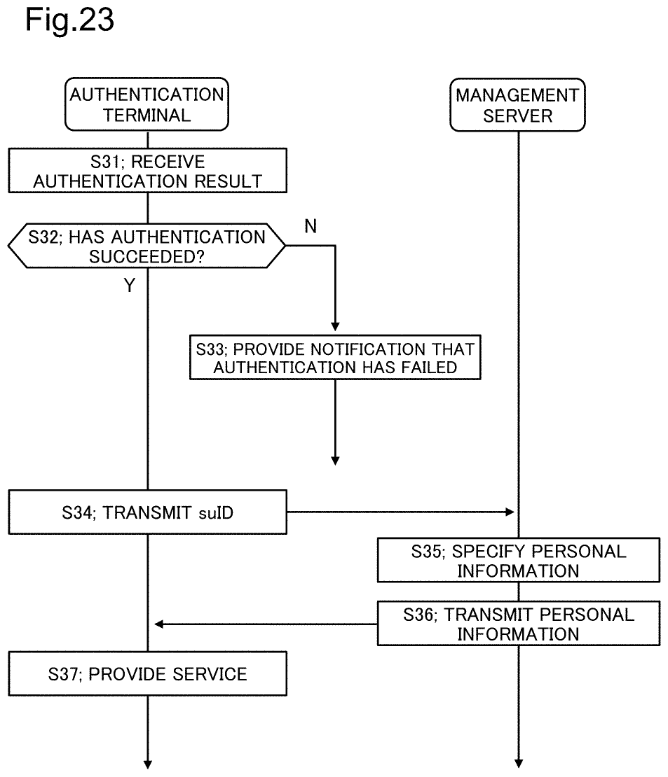

FIGS. 22 and 23 are sequence diagrams each illustrating an example of the operation of the authentication system related to the service provision phase according to the first example embodiment. An operation related to processing an authentication request transmitted from the authentication terminal 30 will be described with reference to FIG. 22. An operation related to providing a service by the authentication terminal 30 will be described with reference to FIG. 23.

The authentication terminal 30 acquires biometric information (a face image) of a user, and transmits an authentication request including the biometric information to the authentication server 10 (step S21).

The authentication server 10 processes the acquired authentication request using the user authentication information registered in the authentication information database (step S22).

When the authentication has succeeded (Yes in step S23), the authentication server 10 executes step S29.

When the authentication has failed (No in step S23), the authentication server 10 processes the authentication request using the user authentication information registered in the temporary authentication information database (step S24).

When the authentication has succeeded (Yes in step S25), the authentication server 10 executes step S29.

When the authentication has failed (No in step S25), the authentication server 10 transfers the authentication request acquired from the authentication terminal 30 to another authentication server 10 (step S26).

When receiving the authentication request from another authentication server 10, the authentication server 10 processes the authentication request using the user authentication information registered in the authentication information database (step S27).

The authentication server 10 transmits a result of processing collation (the authentication has succeeded or the authentication has failed) to the source from which the authentication request is transmitted (step S28). At this time, when the authentication has succeeded, the authentication server 10 transmits a response including the service user ID to the authentication server 10 from which the authentication request is transmitted.

The authentication server 10 transmits a result of processing the authentication request to the authentication terminal 30 (step S29). When the authentication has succeeded, the authentication server 10 transmits a positive response including the service user ID to the authentication terminal 30. When the authentication has failed, the authentication server 10 transmits a negative response to the authentication terminal 30.

The authentication terminal 30 receives the authentication result from the authentication server 10 (step S31 in FIG. 23).

When the authentication result from the authentication server 10 is “the authentication has failed” (No in step S32), the authentication terminal 30 notifies the user of the fact (step S33).

When the authentication result from the authentication server 10 is “the authentication has succeeded” (Yes in step S32), the authentication terminal 30 transmits a service user ID included in the response from the authentication server 10 to the management server 20 (step S34).

The management server 20 searches the user information database using the acquired service user ID as a key, and specifies corresponding personal information (step S35).

The management server 20 transmits the specified personal information to the authentication terminal 30 (step S36).

The authentication terminal 30 provides a service using the received personal information (step S37).

As described above, the authentication system according to the first example embodiment includes a plurality of authentication servers 10, and each of the authentication servers 10 stores user authentication information about some of all system users. Each authentication server 10 processes an authentication request from a terminal using the user authentication information stored in itself. That is, in the authentication system according to the first example embodiment, a plurality of authentication servers 10 that manage user authentication information are provided, and the user authentication information is allocated to the authentication servers 10 in a distributed manner. As a result, an amount of data stored (managed) by each authentication server 10 can be reduced, thereby ensuring sufficient precision of authentication. Furthermore, in the authentication system according to the first example embodiment, the authentication server 10 detects a change in current position of the user. When the current position of the user is outside a responsible area of the authentication server 10, the authentication server 10 transmits the user authentication information of the user to an authentication server 10 that manages an area including the current position of the user. By transferring the user authentication information as described above, collation can be smoothly processed even if the user moves to an area different from the area managed by the authentication server in which the user authentication information is registered.

In the authentication system according to the first example embodiment, the authentication server 10 biometrically authenticates a user using a three-stage collation method (authentication method). The three-stage collation is performed in descending order of probability of success in authenticating the user. That is, if the current position of the user is within the range of the action area initially registered in the system, a collation process is executed using the biometric information registered in the permanent database. Therefore, unless the user is transferred or goes on a business trip or the like, the biometric authentication of the user succeeds in this collation processing. When the current position of the user changes from the initial action area and the system grasps the change, a collation process is executed using the feature amount registered in the temporary database. Therefore, in a case where the user or the like goes on a business trip or the like while carrying the terminal 40, the biometric authentication of the user succeeds in the second-stage collation process. In a case where the user moves while not carrying the terminal 40, a collation process is executed using the biometric information stored in one of the authentication servers 10 of the system. Therefore, even when the authentication server 10 does not grasp the current position of the user, the biometric authentication of the user registered in the system succeeds. As described above, in the first example embodiment, the collation processes are executed in descending order of likelihood of success in authenticating the user. In addition, by executing the collation processes in the above-described order, it is also possible to increase a processing speed required for authentication. That is, for most users who have no change in action area, the authentication succeeds in an initial authentication process, and thus, a short period of time is required for the process. On the other hand, when the authentication of the user succeeds in a third-stage authentication process, a long period of time is required for the process. However, it is rare that the user is outside the initial action area while not carrying the terminal 40, and thus, such a situation does not cause a big problem.

In addition, in the authentication system according to the first example embodiment, the biometric information of the user is stored in the authentication server 10, whereas no service provider has the biometric information. The personal information of the user is stored in the management server 20 managed and operated by the service provider, whereas no authentication server 10 has the personal information. By arranging information in a distributed manner as described above, the authentication system according to the first example embodiment provides a robust authentication base against information leakage. That is, the biometric information (particularly, feature amounts) not associated with the personal information is merely a list of numerical values, and is information of low value for criminals or the like. Therefore, even if information leakage occurs from the authentication server 10, the influence thereof is limited. Such a configuration enables participants (a user who is provided with a service and a service provider who provides a service) in the authentication system to use the authentication system with security.

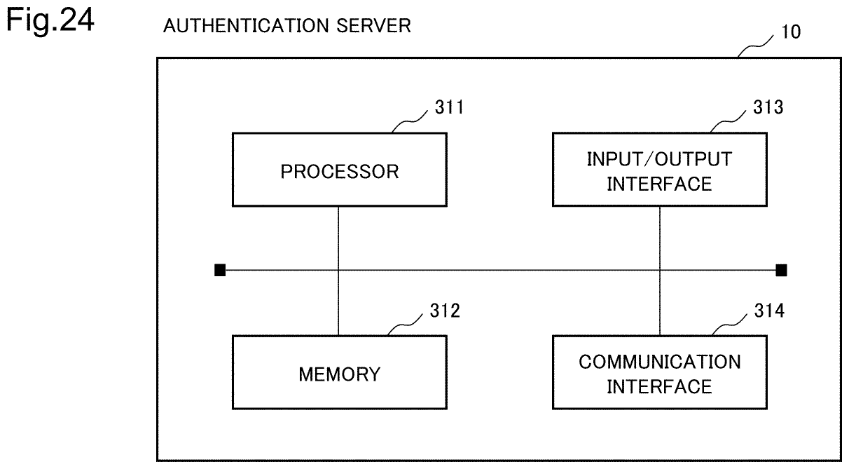

Next, hardware of each device constituting the authentication system will be described. FIG. 24 is a diagram illustrating an example of a hardware configuration of the authentication server 10.

The authentication server 10 can be configured by an information processing device (a so-called computer), and has a configuration illustrated in FIG. 24. For example, the authentication server 10 includes a processor 311, a memory 312, an input/output interface 313, a communication interface 314, etc. The components such as the processor 311 are connected to each other by an internal bus or the like, and are configured to be able to communicate with each other.

However, the configuration illustrated in FIG. 24 is not intended to limit the hardware configuration of the authentication server 10. The authentication server 10 may include hardware that is not illustrated, or may not include the input/output interface 313 if necessary. In addition, the number of processors 311 and the like included in the authentication server 10 is not limited to the example of FIG. 24, and for example, a plurality of processors 311 may be included in the authentication server 10.

The processor 311 is a programmable device, e.g., a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various kinds of data.

The input/output interface 313 is an interface of a display device or an input device that is not illustrated. The display device is, for example, a liquid crystal display or the like. The input device is, for example, a device that receives a user's operation such as a keyboard or a mouse.

The communication interface 314 is a circuit, a module, or the like that communicates with another device. For example, the communication interface 314 includes a network interface card (NIC) or the like.

The functions of the authentication server 10 are achieved by various processing modules. The processing modules are implemented, for example, by the processor 311 executing the programs stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Furthermore, the processing module may be implemented by a semiconductor chip.

The management server 20, the authentication terminal 30, the terminal 40, and the like can also be configured by information processing devices similarly to the authentication server 10, and they are not different in basic hardware configuration from the authentication server 10. Thus, the description thereof will be omitted. For example, the authentication terminal 30 may include a camera for imaging a user.

The authentication server 10 has a computer mounted thereon, and the functions of the authentication server 10 can be achieved by causing the computer to execute the program. In addition, the authentication server 10 executes an authentication server control method through the program.

### [Modifications]

Note that the configuration, operation, and the like of the authentication system described in the above example embodiment are merely examples, and are not intended to limit the configuration and the like of the system.

In the above example embodiment, it has been described that a user determines a user ID and a password, such that the user (system user) registered in the system is specified using the user ID and the password. However, the authentication system may determine an ID (identifier) that uniquely identifies a system user. For example, in the user registration phase, the authentication server 10 acquires biometric information (a face image or a feature amount) of a user. The authentication server 10 may generate the ID based on the biometric information. For example, the authentication server 10 may calculate a hash value from the feature amount of the face image, and use the calculated hash value instead of the user ID and the password. A feature amount of a face image is different for each user and a hash value generated from the feature amount is also different for each user, and thus, the hash value can be used as an ID of a system user.

In the above example embodiment, it has been described that the authentication server 10 holds biometric information for authentication and the management server 20 holds personal information for service provision, thereby enhancing the safety of the system. However, the arrangement of the information (biometric information and personal information) is not limited to the above-described distributed arrangement, and the authentication server 10 may store the biometric information and the personal information in association with each other. That is, the function of the management server 20 may be implemented by the authentication server 10.

In the above example embodiment, it has been described that one representative server is determined in advance among the plurality of authentication servers 10. The selection of the representative server is not limited to the above-described method. For example, a representative server may be determined by a round robin method. For example, the authentication server 10-1 and the authentication server 10-2 may alternately operate as representative servers. Alternatively, a representative server may be determined depending on a time zone. For example, the authentication server 10-1 may operate as a representative server at daytime, and the authentication server 10-2 may operate as a representative server at nighttime.

In the above example embodiment, it has been described that the terminal 40 reports its current position to the authentication center, so that the authentication server 10 grasps a current position of a user. However, the authentication server 10 may grasp a current position of a user using another method. For example, a service provider visited by a user may notify the authentication server 10 of a current position of the user. For example, when a user carrying the terminal 40 enters a store or the like of a service provider, the authentication terminal 30 communicates with the terminal 40 through a communication means such as Bluetooth (registered trademark). The authentication terminal 30 acquires a user ID, a password, and connected server information from the terminal 40. The authentication terminal 30 transmits the user ID, the password, and information including a position of authentication terminal 30 (information equivalent to current position information) to an authentication server 10 corresponding to the connected server information. The authentication server 10 handles the acquired information similarly to the “current position information”, and transmits the user authentication information if necessary.

Alternatively, the authentication server 10 may grasp a current position of the user in cooperation with a base station. More specifically, when the terminal 40 carried by the user is handed over (a base station to communicate with is changed), a base station of a destination to which the terminal 40 is handed over may notify the authentication server 10 of the movement of the terminal 40. In this case, the authentication server 10 may grasp the current position of the user from information on a position of each base station.

Alternatively, an action area of a user may be stored in the terminal 40, and the terminal 40 may transmit current position information to the authentication server 10 using the action area. For example, the terminal 40 periodically calculates a current position, and determines whether the calculated current position is included in the action area. When the current position is outside the action area, the terminal 40 may transmit current position information to the authentication server 10. By taking such a countermeasure, it is possible to reduce an amount of communication from the terminal 40 to the authentication server 10.

In the above example embodiment, it has been described that when the second-stage authentication (authentication using the temporarily stored user authentication information) has failed, the authentication request is broadcast to another authentication server 10. However, priority may be given to an authentication server 10 that transmits an authentication request. For example, referring to a history regarding the movement of the user, the authentication server 10 may determine an authentication server 10 to which an authentication request is to be transmitted according to the history. For example, it is assumed that three authentication servers A to C are included in the system, and the authentication server A is responsible for an action area R1, the authentication server B is responsible for an action area R2, and the authentication server C is responsible for the action area R3. In addition, it is assumed that an action area of a user U4 registered in the system is R1, user authentication information of the user U4 is stored in the authentication server A, and the user U4 is located in the area R3 while not carrying the terminal 40. In this case, the authentication server C processes an authentication request of the user U4. Since the authentication server C does not hold the user authentication information of the user U4 and the user U4 does not carry the terminal 40, first-stage authentication and second-stage authentication fail. The authentication server C executes a third-stage authentication process. At this time, if the authentication server C grasps that the user U4 have moved to the action area R2 many times due to a business trip or the like, the authentication server C preferentially transmits an authentication request to the authentication server B that is responsible for the action area R2 at the time of the third-stage authentication. When it is not notified that the authentication has succeeded from another authentication server 10 to which the authentication request has been preferentially transmitted on the basis of the action history of the user, the authentication server 10 may transmit (broadcast) the authentication request to a server other than the another authentication server 10 to which the authentication request has been preferentially transmitted. In the above-described example, when the authentication server C is not notified from the authentication server B that the authentication has succeeded, the authentication server C may transmit the authentication request to the authentication server A.

In the above example embodiment, it has been described that the user registration phase and the service registration phase are executed at different timings, but these phases may be executed at the substantially same timing. For example, the above-described two registration phases may be executed, using the authentication terminal 30 installed in a service provider from which the user desires to be provided with a service. Specifically, by using the authentication terminal 30, the user may register a user (input biometric information, a user ID, a password, and an action area), and then consecutively register a service (input personal information and the like). In this case, the authentication terminal 30 may have a user registration function (the user registration unit 202) of the authentication server 10 and a personal information acquisition function (the personal information acquisition unit 302) of the management server 20.

A plurality of authentication terminals 30 possessed by a service provider may not be installed at the same site, building, or the like. The authentication terminals 30 may be installed at spatially separated places if possessed by the same service provider.

In the above example embodiment, it has been described that one service provider ID is assigned to one service provider, but one service provider ID may be assigned to a plurality of service providers. A plurality of service providers may be classified into groups, and a service provider ID may be issued for each group. For example, in a case where the service providers S1 and S2 provide the same service in cooperation with each other, a common service provider ID may be issued to the service providers S1 and S2.

In a case where a user leaves an action area initially registered in the system, user authentication information is transferred (copied). At this time, notification of the occurrence of the transfer may be provided to the user or a system administrator. Alternatively, in a case where the user authentication information does not exist in an authentication server 10 that is responsible for a user's action area and an authentication process is requested to another authentication server 10, notification of the occurrence of the request may be provided to the administrator or the user. By receiving such a notification, the user or the like can know the reason why it takes a long time for the authentication process, which is normally supposed to end immediately.

In the above example embodiment, it has been described that the system collects a current position of a user, but the user may report his/her current position. Alternatively, the user may input his/her schedule to the system with a designated period. For example, the user inputs information “yyyy/mm/d1 to yyyy/mm/d2; a business trip to Kanto” the system. The authentication server 10 transfers the user authentication information, if necessary, based on the input information (copies the user information to another authentication server 10). The authentication server 10 deletes the temporarily stored user authentication information after a time period stated by the user elapses.

In the above example embodiment, it has been described that biometric information related to “a feature amount generated from a face image” is transmitted from the authentication terminal 30 to the authentication server 10. However, biometric information related to “a face image” may be transmitted from the authentication terminal 30 to the authentication server 10. In this case, the authentication server 10 may generate a feature amount from the acquired face image, and execute an authentication process (collation process).

In the above example embodiment, it has been described that the authentication terminal 30 acquires a face image, and the management server 20 generates a feature amount from the face image. However, the authentication terminal 30 may generate a feature amount from the face image, and transmit the generated feature amount to the management server 20. That is, the management server 20 may not perform the generation of the feature amount.

In the above example embodiment, it has been described that a user inputs a user ID and a password to a service provider when registering personal information in the service registration phase (see FIG. 16). However, instead of the user ID and the password, biometric information (face image) of the user may be input to the service provider. In this case, the management server 20 transmits a service registration request including a feature amount generated from a face image and a service provider ID to the authentication server 10. The authentication server 10 executes a collation process using the feature amount included in the request and the feature amount registered in the authentication information database, and specifies a corresponding user. When succeeding in specifying (authenticating) a user, the authentication server 10 dispenses a service user ID. By taking such a countermeasure, even when the user forgets his own user ID and password, the user can easily register a service. Alternatively, the service provider may acquire biometric information (face image) of the user in addition to the user ID and the password. In this case, when the user ID, the password, and the biometric information match, the authentication server 10 may dispense a service user ID (two-factor authentication may be executed using the biometric information and the password).

In the above example embodiment, it has been described that the two databases, i.e., the authentication information database and the temporary authentication information database, are used, but these databases may be integrated to use one database. That is, a “set date and time field” and a “TTL field” may be provided in the authentication information database, values may be set in these fields for the user authentication information acquired from another authentication server 10, and corresponding entries may be deleted after a predetermined time period elapses. By taking such a countermeasure, collation using the user authentication information registered in the temporary authentication information database can be performed by a one-time authentication process, thereby increasing a processing speed required for authentication.

A form of data transmission and reception between the devices (the authentication server 10, the management server 20, and the authentication terminal 30) is not particularly limited, but data transmitted and received between the devices may be encrypted. When biometric information is transmitted and received between these devices, it is preferable that the transmitted and received data is encrypted in order to appropriately protect the biometric information.

In the flow charts (flowcharts or sequence diagrams) used in the above description, a plurality of steps (processes) are described in order, but an order in which the steps are executed according to the example embodiment is not limited to the described order. According to the example embodiment, the order of the steps as illustrated can be changed without departing from the gist, for example, executing the processes in parallel.

The above example embodiment has been described in detail to make it easy to understand the disclosure of the present application, and it is not intended that all the configurations described above are necessary. In addition, in a case where a plurality of example embodiments have been described, the example embodiments may be used each alone or in combination. For example, some configurations of one example embodiment can be replaced with configurations of another example embodiment, or configurations of one example embodiment can be added to configurations of another example embodiment. Furthermore, some configurations of each example embodiment can be deleted, or added or replaced to or with other configurations.

Although the industrial applicability of the present invention is apparent from the above description, the present invention can be suitably applied to an authentication system or the like for authenticating a customer at a retail store, a hotel business, or the like.

Some or all of the above-described example embodiment can be described as in the following Supplementary Notes, but are not limited to the following Supplementary Notes.

### [Supplementary Note 1]

An authentication server including:

a first database that stores user authentication information for performing authentication using biometric information for some of a plurality of users; and

an authentication unit that processes an authentication request from a terminal using the user authentication information stored in the first database.

### [Supplementary Note 2]

The authentication server according to Supplementary Note 1, further including a second database that temporarily stores the user authentication information stored in the first database included in another authentication server.

### [Supplementary Note 3]

The authentication server according to Supplementary Note 2, in which when the authentication using the user authentication information stored in the first database fails, the authentication unit processes the authentication request using the user authentication information stored in the second database.

### [Supplementary Note 4]

The authentication server according to Supplementary Note 3, in which when the authentication using the user authentication information stored in the second database fails, the authentication unit requests the another authentication server to process the authentication request from the terminal.

### [Supplementary Note 5]

The authentication server according to any one of Supplementary Notes 1 to 4, in which the first database stores the user authentication information for a user whose action area is included in a responsible area assigned to the authentication server among the plurality of users.

### [Supplementary Note 6]

The authentication server according to Supplementary Note 5, further including an authentication information control unit that transmits the user authentication information for the user outside the responsible area, when a current position of the user corresponding to the user authentication information stored in the first database is outside the responsible area assigned to the authentication server, to another authentication server that is responsible for an area including the current position of the user.

### [Supplementary Note 7]

The authentication server according to any one of Supplementary Notes 1 to 6, in which the user authentication information includes an ID for uniquely determining a user and biometric information of the user.

### [Supplementary Note 8]

An authentication system including:

a plurality of authentication servers, each including a first database that stores user authentication information for performing authentication using biometric information for some of a plurality of users; and

an authentication terminal that transmits an authentication request including biometric information for the user to a predetermined authentication server among the plurality of authentication servers,

in which the authentication server receiving the authentication request processes the received authentication request using the user authentication information stored in the first database.

### [Supplementary Note 9]

The authentication system according to Supplementary Note 8, further including a terminal that transmits current position information including a current position to an authentication server determined according to an action area of the user among the plurality of authentication servers.

### [Supplementary Note 10]

The authentication system according to Supplementary Note 9, in which when the current position of the user is outside a responsible area assigned to the authentication server receiving the current position information, the authentication server transmits user authentication information for the user outside the responsible area to another authentication server that is responsible for an area including the current position of the user.

### [Supplementary Note 11]

The authentication system according to Supplementary Note 10, in which each of the plurality of authentication servers further includes a second database that temporarily stores the user authentication information for the user outside the responsible area.

### [Supplementary Note 12]

The authentication system according to any one of Supplementary Notes 8 to 11, in which the authentication terminal transmits the authentication request to the authentication server that is responsible for an area where the authentication terminal is installed among the plurality of authentication servers.

### [Supplementary Note 13]

An authentication server control method performed by an authentication server, the authentication server control method including:

storing, in a first database, user authentication information for performing authentication using biometric information for some of a plurality of users; and

processing an authentication request from a terminal using the user authentication information stored in the first database.

### [Supplementary Note 14]

A computer-readable storage medium storing a program for causing a computer mounted on an authentication server to execute processing including:

storing, in a first database, user authentication information for performing authentication using biometric information for some of a plurality of users; and

processing an authentication request from a terminal using the user authentication information stored in the first database.

Note that the disclosures of the cited prior art documents are incorporated herein by reference. While the example embodiments of the present invention have been described above, the present invention is not limited to these example embodiments. It will be understood by those of ordinary skill in the art that these example embodiments are merely exemplary and various variations may be made without departing from the scope and spirit of the present invention. That is, it goes without saying that the present invention includes various modifications and alterations that can be made by those skilled in the art in accordance with the entire disclosure including the claims and the technical idea.

### REFERENCE SIGNS LIST

10, 10-1, 10-2, 100 authentication server
20, 20-1, 20-2 management server
30, 31, 30-1 to 30-4, 31-1, 31-2 authentication terminal
40, 40-1, 40-2 terminal
101 first database
102, 206 authentication unit
201, 301, 401, 501 communication control unit
202 user registration unit
203, 304 database (DB) management unit
204 service registration unit
205 authentication information control unit
207, 306, 406, 503 storage unit
302 personal information acquisition unit
303 service registration request unit
305 personal information provision unit
311 processor
312 memory
313 input/output interface
314 communication interface
402 biometric information acquisition unit
403 authentication request unit
404 service provision unit
405 message output unit
502 current position information generation unit

What is claimed is:

1. An authentication server comprising:
a first database that stores user authentication information for performing authentication using biometric information for some of a plurality of users; and
at least one processor configured to process an authentication request from a terminal using the user authentication information stored in the first database.

2. The authentication server according to claim 1, further comprising a second database that temporarily stores a user authentication information stored in a first database included in another authentication server.

3. The authentication server according to claim 2, wherein when the authentication using the user authentication information stored in the first database fails, the at least one processor processes the authentication request using the user authentication information stored in the second database.

4. The authentication server according to claim 3, wherein when the authentication using the user authentication information stored in the second database fails, the at least one processor requests the another authentication server to process the authentication request from the terminal.

5. The authentication server according to claim 1, wherein the first database stores the user authentication information for a user whose action area is included in a responsible area assigned to the authentication server among the plurality of users.

6. The authentication server according to claim 5, wherein the at least one processor is further configured to transmit the user authentication information for the user outside the responsible area, when a current position of the user corresponding to the user authentication information stored in the first database is outside the responsible area assigned to the authentication server, to another authentication server that is responsible for an area including the current position of the user.

7. The authentication server according to claim 1, wherein the user authentication information includes an ID for uniquely determining a user and biometric information of the user.

8. An authentication system comprising:
a plurality of authentication servers, each including a first database that stores user authentication information for performing authentication using biometric information for some of a plurality of users; and
an authentication terminal that transmits an authentication request including biometric information for the user to a predetermined authentication server among the plurality of authentication servers,
wherein the authentication server receiving the authentication request processes the received authentication request using the user authentication information stored in the first database.

9. The authentication system according to claim 8, further comprising a terminal that transmits current position information including a current position to an authentication server determined according to an action area of the user among the plurality of authentication servers.

10. The authentication system according to claim 9, wherein when the current position of the user is outside a responsible area assigned to the authentication server receiving the current position information, the authentication server transmits user authentication information for the user outside the responsible area to another authentication server that is responsible for an area including the current position of the user.

11. The authentication system according to claim 10, wherein each of the plurality of authentication servers further includes a second database that temporarily stores the user authentication information for the user outside the responsible area.

12. The authentication system according to claim 8, wherein the authentication terminal transmits the authentication request to the authentication server that is responsible for an area where the authentication terminal is installed among the plurality of authentication servers.

13. An authentication server control method performed by an authentication server, the authentication server control method comprising:
storing, in a first database, user authentication information for performing authentication using biometric information for some of a plurality of users; and
processing an authentication request from a terminal using the user authentication information stored in the first database.

14. (canceled)
